(19) United States
(12) Patent Application Publication
(10) Pub. No.: US 2026/0368669 A1
(43) Pub. Date: Nov. 19, 2026

(54) SYSTEM AND METHOD OF MANAGING WORKFLOW FOR AN OBSERVED EVENT

(71) Applicant: Task Watch Corporation, Mason, OH (US)

(72) Inventors: Bharat A. Saini, Mason, OH (US); Vivek B. Saini, Ridgewood, OH (US)

(73) Assignee: Task Watch Corporation, Mason, OH (US)

(21) Appl. No.: 19/700,882

(22) Filed: Jun. 8, 2026

Related U.S. Application Data
(63) Continuation-in-part of application No. 18/619,980, filed on Mar. 28, 2024, now Pat. No. 12,699,941.
Application No. 18/619,980 is a continuation-in-part of application No. 18/535,831, filed on Dec. 11, 2023, now Pat. No. 12,682,301.
Application No. 18/535,831 is a continuation-in-part of application No. 17/682,269, filed on Feb. 28, 2022, now Pat. No. 11,880,795.
Application No. 17/682,269 is a continuation of application No. 17/564,959, filed on Dec. 29, 2021, now abandoned.

(51) Int. Cl. G06Q 10/0633; G06Q 10/0631

(52) U.S. Cl. CPC G06Q 10/0633; G06Q 10/063112

(57) ABSTRACT

A system and method having an automated device and one or more image captured apparatus are used to captured images which are used to detect an event and determine if the event is a recognized event and if the event is a recognized event, a workflow is transmitted to the automated device for responding to the recognized event that adjust the operation of the automated device.

### BACKGROUND OF THE INVENTION

This application is a continuation-in-part and claims benefit to, in its entirety, U.S. Patent application no. 18/619,980 filed Mar. 28, 2024 with is a continuation -in-part to and claims benefit to, in its entirety, U.S. patent application no. 18/535,831 filed on Dec. 11, 2023 which is a continuation-in-part of and claims benefit to, in its entirety, U.S. patent no. 11,880,795 issued Jan. 23, 2024, which is a continuation of and claims benefit to, in its entirety, to U.S. patent application no. 17/564,959 filed on Dec. 29, 2021 and now abandoned.

The present invention relates to computer-aided interactive system that provides a computer-aided interactive method and system whereby images, such as streaming images, are analyzed and when an event is detected an appropriate workflow is identified and transmitted to a system, such as to the control apparatus of a robotic device or a manufacturing system or a machine (hereinafter collectively referred to as an “automated device”) which can then implement the workflow. Further, the present invention provides a system that allows the monitoring of an automated device as it performs the assigned workflow and/or as it moves through a location or performs manufacturing or machine operations and provides the ability for automated control of an automated device to adjust its operation in response to an encountered event.

Many businesses today, particularly large businesses, have a multitude of individuals that operate on the premises of large building centers and are responsible for performing various tasks. One problem with such businesses (such as hospitals, stores, warehouses, manufacturing plants, and other similar places) is that it is difficult for them to monitor and take timely action on observed events that may be taking place at various

locations on the property or with regard to various manufacturing systems or machines. This is particularly problematic in areas on the property where there is few or any individuals at that location. Further, individuals are often not at their work site or location, such as when the individual decides to have lunch or take a break. Accordingly, events may take place at that location which are not observed or there is no individual available to respond to a detected event. Further, some events migrate or move through a location or system and it is difficult to determine if an event identified at one area of a location or system has migrated or moved to another area or if events detected by two different sensors are the same identified event. While detection systems and methods have been developed that record information and conditions at a location (such as for example in a manufacturing facility or warehouse) or along a system (such as for example along a manufacturing line or conveyor line), such as by use of cameras that take images at a location or warning systems that detect potential environmental concerns, such as smoke detectors, heat detectors, gas detectors, and the like, such systems either only record conditions, such as generating data for after-the-fact analysis or images taken by a camera, or detect that a concern exist, but do not mitigate risks at the time the events are detected at that location or direct automated devices to perform a workflow based on a detected event or operate to detect and identify events based on images taken at a location or along a system. Further, such detection systems do not operate to detect certain events, such as an individual that may have fallen or that something may have spilled causing a potentially hazardous condition. In addition, if a dangerous condition is detected (an event), it often takes time for management to identify the event and take appropriate action. Such a time delay could result in an event growing in size and danger. Further, current detection systems and methods do not operate to detect and identify events using one or more images or from a sequence of the detected events or time periods between such detected events. In addition, events identified at one location, such as by use of an image taken by one image capture apparatus, may not be a concern unless the event is detected and identified using images captured by other image capture apparatus or uses images taken at different times.

Many such events can be for effectively resolved using automated devices, such as movable robotic device, that moves and enter hostile environments, such as caused by fire or chemical spills, or are static and in a fixed position within a location. As described herein, it has been found that such movable robotic devices can operate effectively using optical sensors that can scan the location and using images obtained by such optical sensors evaluate the event and using analysis and response software that utilize systems such as Machine Learning Software (Artificial Intelligence (AI) programming), can identify the event and develop workflow and direct response software to transmit the workflow to the control apparatus of an automated device that operates to perform the appropriate workflow.

Automated devices, such as movable robotic devices for transporting objects to or from a location, such as carts, forklifts, pallet jacks and overhead cranes are well known and have been automated by gantry systems that typically utilize pulling chains in the X and Y directions to control the path of the objects being transported to a desired location. Such movable robotic devices often have a control apparatus with a motion controller, such as a motion coordinate control apparatus, in combination with a Human Machine Interface (HMI) that allows an operator to identify an end point, such as a point on a floor map, and the control apparatus operates to direct the robotic device to transport the object to the desired endpoint location, such as an unloading station. However, this requires an individual to interact with such robotic device. With the development of Machine Learning Software (AI programming), it would be desirable to utilize an information retrieval system that can continuously monitor such robotic devices and provide information for use by the Machine Learning Software to detect events and if an event is detected, provide a concern level and the appropriate workflow to respond to the event.

Movable robotic devices, such as an Autonomous Guided Vehicle (AGV), have also been developed that allow for the transportation of objects without the need for operators to directly control them or the need for fixed rail tracks. Such devices typically include a Human-Machine-Interface that allows an operator to input modifications to the device’s operation, such as to direct the device to pick up and transport objects to a specified location. AGVs often operate such that they move as scheduled to a loading station or are directed to a loading location when needed and typically follow the same path to go to an assigned unloading station. Such autonomous devices are also designed to stop, avoid and steer around humans or other obstacles that occur along their path of travel. One problem with such AGVs is that an event may occur that is not easily detected by conventional sensors used by such AGVs. For example, if an obstruction occurs along the assigned path, or an object to be transported is not precisely positioned at a defined loading station, or the path is only temporary (short term) blocked, or if the unloading station has articles that prevents the device to offload the object being transported or an object being transported falls off the AGV as the device travels along its path. Currently, such devices typically require a multitude of different sensors to detect such events or may detect an event but the sensors do not provide a sufficient amount or type of information to properly assess the event, particularly when the event is being analyzed by Machine Learning Software. With the development of Machine Learning Software (AI programming), events can be properly assessed and appropriate responses (workflows) can be implemented provided the Machine Learning Software (AI programming) has sufficient information for properly assessing the event by the Machine Learning Software.

A network connection is often employed to communicate with an AGV and is typically standard off-the-shelf secured wireless technology that may already exists at the location. The connection is designed to use as little network bandwidth as possible. Since an AGV has the ability to operate autonomously for some period of time, it is not necessary to be in constant real time communication with the master control unit. Some path tracking systems used by an AGV employ navigation devices such as magnets or other markers positioned on the floor to indicate pathways, rooms and no-go zones while other AGVs use path tracking systems that are preprogrammed floor map-based systems. Most of the preprogrammed floor map-based systems require a preexisting floor map of the path space and operate to train the motion controller of the AGV where any boundaries lie within the control area. Directional sensors, such as laser or sonar, are used during training to help map additional permanent fixtures that are not on the floor plan (such as desks, partitions, and machinery, etc.). Without such sensors, an AGV would often get “lost” during operation because the rotary servo driving the wheels of the AGV would not account for motion errors, such as wheel slippage. Typically, an AGV operates to maintain an approximate location of the AGV by having sensors of the AGV that interact with electronic markers on the walls and/or fixed articles located within the location to a floor map. Unfortunately, such path tracking systems are not as effective for large amorphous control areas, such as a warehousing location, where there are not as many fixed unmovable articles to attach markers to, thereby increasing the likelihood of position inaccuracies.

Global Position Satellite systems (GPS) have been developed and are accurate enough for most outdoor purposes. Various other systems and methods have also been developed using different sensors and include, for example, the use of a compass to map the magnetic signature of various locations against the floor plan map; using multiple Wi-Fi hub signals strength to a fingerprint of each location against a floor plan map; and counting the steps and inferring directions an AGV is moving. However, none of these location methods have proven accurate enough by themselves for many applications. Further, while in certain control areas the path tracking systems do operate to provide the needed accuracy in to determine the location of an AGV along a path, there is no ability to adjust the path parameters or the path of travel of the AGV to ensure that the AGV arrives at an unloading station at a specified or scheduled time. Further, while such path tracking systems can monitor the location of the AGV, they do not provide a system for detecting various events.

For many applications, assembly or manufacturing systems require positioning systems that are reliable and precision accurate. Wireless, GPS and conventional Radio Frequency Identification (RFID) signal strength triangulation systems have been employed and are relatively inexpensive. However, they often do not provide the required accuracy for many applications. Magnetic tape or optical scale markers have been used with linear slides and with AGVs but are often difficult to use along an entire predefined path or to achieve the desired accuracy. Further, free operating devices that stray off the predefine path can get lost and are unable to automatically return to their predefined path and it is difficult for control systems to redirect the AGV to a desired path.

Automated devices, such as manufacturing systems, are also now highly automated having programmable control apparatus, such as PLCs, connected to servomotors, running mechanical assemblies and the like. Such manufacturing devices often include conveyor systems whereby objects, such as products, containers, or totes (“objects”) travel down a conveyor to an unloading station where unloading devices mechanically place the objects into shipping or storage containers. Unfortunately, often objects often fall off (an event) such conveyors or are turned or are not in their proper position or orientation (an event), often caused by vibration or disruption in the smooth operation of the conveyor (an event), that can cause a backup of objects (an event) moving along the conveyor or preventing their proper unloading. Further, the unloading devices that remove objects from the conveyor and stack the objects in a desired arrangement for placing the objects into shipping containers can malfunction (an event). For example, stacked objects may fall or not remain in their proper orientation causing misfunctioning of the unloading process resulting in the desired number of objects not being properly placed into a shipping container or causes stoppage of the unloading operation. Accordingly, such systems often require an individual to continuously monitor the operation to identify any such problems or sensors may be used to detect such events but often do not provide sufficient information to properly asses the event or its concern level (such that for example, the event only occurring infrequently).

Automated devices, such as machines, often have complex and often dangerous mechanisms. Machines used in industrial operations usually have a plurality of moving parts and/or electrically operated devices. Many such machines have sensors and other monitoring systems that are integrated within critical areas for monitoring operating conditions and machine performance. In the event that the monitoring system identifies that the performance of the machine is degrading or that a potential problem is developing, the monitoring system will perform a predetermined operation, such as sending a warning to a master controller or operates to stop the operation of the machine or the industrial operation. Unfortunately, many events are not easily or detected that can affect the operation of the machine. For example, machines manufacturing articles may be operating properly, however the machine may be improperly placing such manufactured articles in receptacles for transport to another machine for additional manufacturing or assembly. For example, the machine is not placing the newly manufactured article in its proper placement for further manufacturing or for placement in containers for shipment while sensors are showing the machine is not overheating or has high vibration levels or other such indication that the machine is malfunctioning. Thus, such events are often not detected by machine operational sensors.

Machine operators have been known to remove or modify various safety devices, such as coverings or windows blocking dangerous operations, in order to make the machining easier for the operator. While supervisors may often examine such machines to ensure that safety devices are properly positioned on the machines, operators often remove such safety devices after such inspections. While cameras are often installed to monitor operations, they require individuals to monitor such machining operations which significantly increase operational expenses.

Many systems have also been developed having image capture apparatus that take images, such as cameras, that are strategically positioned within an area of a location to monitor various operations. While individuals monitoring such devices can detect movement using captured images and can recognize that the same object in an image taken by one image capture apparatus is the same object in an image taken by another image capture apparatus capturing images of an object within another area, it is difficult for an automated system to identify that an image of an object taken from one image capture apparatus is the same object shown in the image taken by another image capture apparatus. The ability to identify that an image of an object taken from one image capture apparatus is the same object shown in an image taken by another image capture apparatus is particularly desirable when there are numerous objects moving through a specific location, such as on a conveyor or a movable robotic device traveling through a location.

Many systems have been developed that use sensors and other types of sensing devices that operate to take images. Systems have also been developed that can detect color changes that the sensor has been configured to detect. However, until now, a system has not been developed that uses a baseline color (or monochromatic) or color (gray scale) pattern and compares changes in color (or monochromatic) or a color (or gray scale) pattern to determine what that particular color (or grays) change or color (or gray scale) pattern change may indicate, such as the occurrence of an event, and a response (workflow) is selected based on the particular color (or gray scale) change or color (or gray scale) pattern change. Accordingly, unlike previous designed systems, the system and method of the subject invention identify specific responses (workflows) for responding to events that produced the various detected changes in captured images or changes in color or color (gray scale) patterns in the captured images.

Accordingly, what is needed is a system and method whereby images of various operations of an automated device are obtained and used to continuously monitor operations of an apparatus and when an event of interest is detected, the system operates to determine if it is an actionable event (recognized event) requires a response (a workflow) and if so, the system automatically identifies the type of the event, determines the required workflow and transmits the workflow to the control unit or apparatus of an automated device to perform the workflow. A system and method are also needed whereby images of objects, articles and persons (hereinafter collectively referred to as “objects”) and events move through a location, it is tracked across separate image capture apparatus capturing images of various areas, such as along the path of an AGV or operation of a manufacturing device or a machining device. Preferably, the system can identify the object or event as being the same object or event or is a different object or event as taken in another image captured by another image capture apparatus. It is also desirable that the system uses such captured images to detect an event and uses the captured images to identify a workflow and transmit the workflow to the control unit or control apparatus that directs an automated device to implement a workflow.

### Summary of the Invention

A preferred embodiment of the subject invention is a system and method of that identifies observed events and assigns and manages workflows for such observed events. Preferably, the system includes one or more image capture apparatus, such as a camera, that takes images at a location and transmits the images to a control unit having analysis software that includes Machine Learning Software (AI programming) that monitors the images and if an event is detected the Machine Learning Software (AI programming) determines if the event is a recognized event. The analysis software directs the control unit to utilize response software that operates to identify a workflow to be implemented and transmits the workflow to a control apparatus of a device, such as a robotic device or manufacturing device or machine to respond to a recognized event.

In a preferred embodiment of the invention, the response software uses the Machine Learning Software (AI programming) to identify an event and an appropriate workflow for the observed event.

In a preferred embodiment of the invention, the analysis software uses the Machine Learning Software (AI programming) to determine the concern level for the observed event and monitors the observed event and adjusts the concern level over time based on changes occurring with the observed event.

In a preferred embodiment of the invention, the Machine Learning Software (AI programming) of the analysis software further identifies and monitors an event and determines a concern level of the event and based on the concern level, the analysis software directs response software to transmits a workflow to the control apparatus of an automated device.

In a preferred embodiment of the invention, if an event is not a recognized event, the analysis software transmits a notice to an administrator that a non-recognized event has been detected and the administrator determines if a workflow is needed to respond to the non-recognized event, and if a respond is required to respond to the non-recognized event, the administrator determines the appropriate workflow and directs the control unit having response software to transmit the workflow to a control apparatus of the automated device to implement the workflow.

In a preferred embodiment of the invention, the response software utilizes Machine Learning Software (AI software) to identify if an event is a recognized or a non-recognized event and determines a workflow to respond to the event and transmits the workflow to response software that transmits the workflow to a control apparatus of an automated device to implement the workflow.

In a preferred embodiment of the invention, if the event is not a recognized event, the analysis software transmits a notice and one or more of the images to an administrator and whereby the administrator assigns a concern level and/or a workflow to respond to the non-recognized event, whereby the response software transmits the workflow to the control apparatus of an automated device to implement the workflow.

In a preferred embodiment of the invention, the analysis software detects and identifies a plurality of recognized events in a sequence of images or video stream and determines a concern level and/or a workflow based on the sequence of the recognized events.

In a preferred embodiment of the invention, the analysis software detects and identifies a plurality of recognized events in a sequence of images or video stream and determines a concern level and/or workflow based on a time period between the recognized events.

In a preferred embodiment of the invention, if a recognized event has been detected and if the concern level is of a specific level, the response system activates or deactivates or adjusts the operation of the automated device.

In a preferred embodiment of the invention, the one or more image capture apparatus includes or cooperates with one or more condition sensors that monitor conditions at a location.

In a preferred embodiment of the invention, the analysis software uses the conditions at a location to identify a concern value and/or workflow for the event.

In a preferred embodiment of the invention, the workflow provides modifications to the programming of an automated device.

In a preferred embodiment of the invention, when the workflow is being performed by an automated device, the response software communicates with the control apparatus of the device and obtains operating information from one or more sensors connected to the device and transmits the operating information to the analysis software.

In a preferred embodiment of the invention, the analysis software uses operating information to monitor and/or adjust the workflow being performed by the automated device.

In a preferred embodiment of the invention a device includes one or more image capture apparatus that takes images showing the operation of the device and transmits the images to a control unit having analysis software that monitors the images and determines if an event has occurred and if an event has occurred, the analysis software determines a workflow and directs response software to communicate with the control apparatus of the automated device to implement the workflow.

In a preferred embodiment of the invention, a movable automated device includes one or more image capture apparatus that takes images along a path being traveled by the movable automated device and transmits the collected images to a control unit having analysis software that monitors the images and determines if an event has occurred and if an event has occurred, the analysis software determines a workflow and directs response software to communicate with the control apparatus of the movable automated system to implement the workflow.

A preferred embodiment of the system for managing workflows for observed events comprises one or more image capture apparatus that takes color images and transmits the color captured images to a control unit, wherein the control unit having analysis software monitors the collected color captured images to determine if there is a change in color between a color captured image from a previous color captured image; wherein if the analysis software determines that there is a color change, the analysis software identifies a recognized event based on the color change and determines a concern value for the recognized event, wherein the analysis software then directs response software to determine a workflow for responding to the recognized event; wherein the response software interacts with the control apparatus of an appropriate robotic device to perform the workflow.

In a preferred embodiment, wherein if the response software determines a concern level for the recognized event, if the concern level is at a specified level, the response software immediately transmits a workflow to the control apparatus of a robotic device to implement the workflow.

In a preferred embodiment, the analysis software examines pixels and RGB values (color values) creating the color (or monochromatic) captured images and detects any changes in the pixels and RGB values occurring between the color (or monochromatic) captured image to a previously color (or monochromatic) captured image to identify the recognized event.

In a preferred embodiment, the analysis software examines pixels and RGB values (color values) creating the color (or monochromatic) captured images and calculates an average RGB value for each color (or monochromatic) captured images and uses the average RGB values to detect any changes in the average RGB values to determine if there is a change in color (or gray scale) between the color (or monochromatic) captured images, the analysis software then uses the change in color (or gray scale) to identify a recognized event, and wherein the analysis software compares the change in the average RGB values with RGB reference thresholds for the recognized event and if the change in the average RGB values are below the RGB reference thresholds, the analysis software continues to monitor the color (or monochromatic) captured images, and wherein if the change in the average RGB values is equal to or above the RGB reference thresholds, the analysis software determines a concern value and directs the response software to transmit the workflow to the control apparatus of a device to implement the workflow.

In a preferred embodiment, the workflow is further selected based on degree or color (or gray scale) change (the amount of color (or gray scale) change, such as the change in the RGB values).

In a preferred embodiment, the analysis software identifies changes in color (or gray scale) patterns between the color (or monochromatic) captured image and the previously color (or monochromatic) captured image and further uses the change in the color (or gray scale) patterns to identify the registered event.

In a preferred embodiment, the analysis software determines a time period between the captured image and the previous captured image, and wherein the analysis software uses the recognized event and the time period to determine the concern level.

A preferred embodiment of the invention is a system for managing workflows for observed events comprises one or more image capture apparatus that take color images of an event and transmits color captured images to a control unit, wherein the control unit having analysis software that monitors the color captured images and detects any changes in pixels and RGB values and/or color patterns of the color captured images and determines if there is a change in color from a color captured image from a previous color captured image, and if the analysis software determines that there is a color change, the analysis software identifies the event as a recognized event and determines a concern value for the recognized event, and the analysis software then directs response software to the control apparatus of an automated device to implement the workflow, if it is determine that an individual is required to implement the workflow for responding to the recognized event; the response software determines if an individual is needed to perform the workflow and if it is determined that an individual is required to implement the workflow, the response software selects one or more qualified individuals who are qualified to perform the workflow and transmits the workflow and the concern level to individuals input/output device of each selected the one or more qualified individuals, and wherein if the one or more qualified individuals are performing other workflows having concern levels, the one or more qualified individuals perform the workflows in order of the concern levels.

In a preferred embodiment of the invention, the recognized event is selected from a list of recognized events that correspond to the color (or gray scale) change.

In a preferred embodiment of the invention, the workflow is selected from a listing of workflows for the recognized event.

In another preferred embodiment, the analysis software calculates surface area where changes in color (or gray scale) occurs and uses the surface area to determine a concern level.

The method for managing workflows for observed events comprises the steps of: taking images of an event and transmitting the captured images to a control unit; monitoring the captured images to determine if there is a change in color (or gray scale) from a captured image and a previous captured image using changes in the pixels and their RGB values between the captured image and the previous captured image; if there is a color (or gray scale) change between the captured image and the previous captured image, determining if the event is a recognized event and determining a concern value for the recognized event; selecting a workflow for responding to the recognized event; determining if an individual is needed to perform the workflow and if it is determined that an individual is needed to perform the workflow; selecting one or more qualified individuals who are qualified to perform the workflow and transmitting the workflow and the concern level to individuals input/output device of each selected one or more qualified individuals, and wherein if it is determined that an individual is not needed to perform the workflow, interacting with one or more control apparatus controlling an automated device to perform the workflow; and if is determined that an individual is needed to perform the workflow, and wherein if one or more qualified individuals are performing other workflows having concern levels, the one or more qualified individuals perform the workflows in order of the concern levels.

A preferred embodiment of the invention is a system for managing workflows for observed events comprises an image capture apparatus that takes one or more images of an event and transmits the captured images to a control unit, wherein the control unit has analysis software that monitors the images and if an event is detected it determines if the event is a recognized event (for example detects an object in an image) and then calculates movement information of the recognized event (object) using the captured images and assigns an identification tag to the recognized event, wherein using the calculated movement information the analysis software determines a time period that the recognized event should appear in one or more captured images taken by another image capture apparatus and if the recognized event appears in one or more captured images taken by the another image capture apparatus, the analysis software assigns the same identification tag to the recognized event appearing in the image(s) taken by the another image captured apparatus thereby allowing the same recognized event to be tracked as it moves in view from one image capture apparatus into view of another image captured apparatus.

In a preferred embodiment of the invention the captured images are color images.

In a preferred embodiment of the invention movement information includes the direction of movement of the recognized event.

In a preferred embodiment of the invention movement information includes the rate (speed) of movement of the recognized event.

In a preferred embodiment of the invention movement information includes the time period (the amount of time that the recognized event is shown in a captured image taken by and a recognized event is shown in a captured image taken by one image capture apparatus and a recognized event is shown in a captured image taken by another image captured apparatus) between a recognized event shown in an image taken by a first image capture apparatus and a recognized event shown in an image taken by a second image capture apparatus.

In a preferred embodiment of the invention, the analysis software compares the attributes of a first recognized event and the attributes of a second recognized event to determine if the first recognized event and the second recognized event are the same recognized event or are different recognized events, and if the recognized events are the same, the analysis software determines if the concern level for the recognized event should be increased or decreased based on the changes in the attributes.

A preferred embodiment of the invention of a system for managing workflows for observed events comprises a control unit that functions to monitor and control the operation of the overall system having analysis software and response software; one or more image capture apparatus that captures images at a location and transmits said captured images to the control unit; an automated device having control apparatus that can receive control commands from the control unit and preferably has analysis software that can operate independently; wherein the analysis software includes Machine Learning Software; wherein the analysis software continuously monitors captured images and uses the Machine Learning Software to detect the occurrence of an event. If the analysis software detects an event, the analysis software determines if the detected event is a recognized event. Preferably, the analysis software detects the event by using changes in pixels between the captured images over a time period. The analysis software preferably also determines a concern level for the recognized event and determines a workflow to respond to the recognized event preferably based on the concern level and transmits the workflow to a control apparatus of an automated device. The control apparatus performs the workflow that modifies the operation of the automated device. In a preferred embodiment the system for managing workflows for observed events, the automated device is in the form of a manufacturing device. In another preferred embodiment the system for managing workflows for observed events, the automated device is in the form of a machining device. In another preferred embodiment of the invention the system for managing workflows for observed events, the automated device is in the form of a robotic transport device or a movable robotic device.

In another preferred embodiment of the invention the automated device is in the form of a manufacturing device having a conveyor, a loading station having a loading mechanism for placing objects in their proper position on the conveyor forming an object stream and an unloading station having an unloading mechanism for removing the objects from said conveyor. One or more image capture apparatus comprises one or more cameras position to capture images of the conveyor and/or the loading station and/or the unloading station and/or the object stream of the automated device and wherein the captured images are used to identify an event. If the event is a recognized event, the response software transmits a workflow to the analysis software that modifies or controls the operation of the automated device.

In a preferred embodiment, depending on the recognized event and preferably the concern level, the workflow stops operation of the automated device, or adjust the speed of the conveyor; or directs the object stream to different unloading station.

In another preferred embodiment of the invention the system for managing workflows for observed events the automated device is in the form of a machining device having a fixture for securing a work piece in position for machining. Captured images are images showing the fixture and the work piece mounted to the fixture. If the recognized event is a work piece not being properly positioned on the work piece for machining, the analysis software directs the response software to stop operation of the automated device and/or transmits a notice to a machine operator.

In another preferred embodiment of the invention, the automated device is in the form of a machining device and includes a safety mechanism on the automated device. The captured images include images of the safety mechanism and uses the captured images to identify an event. If the analysis software determines that the event is a recognized event, and wherein if the event is a recognized event, such as a modification or removal of the safety mechanism, the analysis software directs the response software to stop operation of the automated device and/or transmits a notice to an administrator. In another preferred embodiment of the invention, the analysis software examines pixels of the captured images and compares the pixels of the captured images with pixels of reference images to identify an event in the captured images.

In another preferred embodiment the analysis software compares changes in the pixels between the captured images and pixels of reference images, if the change in the pixels exceeds a threshold reference, the analysis software directs the response software to determine a workflow based on the concern level for responding to the recognized event and transmits the workflow to the control unit or the control apparatus. In a preferred embodiment, the captured images are images of a work piece after machining and the analysis software compares change in the pixels between the captured images and the reference images and uses the change in pixels to determine if a work piece after machining is within design specifications. If the work piece is outside the design specification, the analysis software directs the response software to determine a workflow for responding to the recognized event and transmits the workflow to the control unit or the control apparatus.

In another preferred embodiment, the automated device is in the form of a robotic transport device freely driven along a predefined path having a loading station and an unloading station. One or more image capture apparatus is mounted on the automated device for capturing images of a location along the predefined path as the automated devices travels along said predefined path. The analysis software continuously monitors the captured images to identify an event and determines if the event is a recognized event. If the event is a recognized event, the response software transmits a workflow, based preferably on the concern level of the recognized event, to the control unit or the control apparatus. If the concern level is below a concern level threshold, the control apparatus performs the workflow by directing the automated device to stop moving along the predefined path until the recognized event is eliminated or if the concern level is equal to or exceeds the concern level threshold, the control apparatus performs the workflow by directing the automated device to move along a new predefined path.

In a preferred embodiment, the response software determines if an individual is needed to perform the workflow. If it is determined that the individual is needed to perform the workflow, the response software selects one or more qualified individuals from a listing of qualified individuals who are qualified to perform the workflow and transmits the workflow and the concern level to individuals input/output device of each one or more selected one or more qualified individuals.

In a preferred embodiment of the invention, if one or more selected qualified individuals are performing other workflows having concern values, the one or more selected qualified individuals perform the workflows in order of the concern values. In a preferred embodiment the analysis software identifies an event by examining changes in the pixels, RGB values, and patterns of the captured images.

In a preferred embodiment, the automated device is moved to a location to perform repairs or perform other workflows (robotic operations) in response to a recognized event. The control commands control the operation of specific components on the automated device designed to perform various robotic operations are programmatically inputted, such as by use of the input devices used by an administrator or transmitted to the control apparatus from the control unit. It should be understood that in a preferred embodiment the control commands and the operation of the automated device and/or its various components, is controlled by the control apparatus using analysis software, preferably using Machine Learning Software, of the automated device without the need to receive control commands from the control unit, thus, the automated device works independently to perform workflows for responding to recognized events identified by the analysis software of the control apparatus.

In a preferred embodiments of the invention the system for managing workflows for observed events comprises a control unit having analysis software and response software; one or more image capture apparatus that captures images at a location and transmits the captured images to the control unit; an automated device having control apparatus; wherein, the analysis software of the control unit includes machine learning software; wherein, the analysis software of the control unit continuously monitors the captured images and uses Machine Learning Software to detect the occurrence of an event, if the analysis software detects an event, the analysis software determines if the detected event is a recognized event; wherein, the analysis software detects the event by using changes in pixels between the captured images over a time period; wherein, the analysis software determines a concern level for the recognized event; wherein, the response software determines a workflow to respond to the recognized event based on the concern level and transmits the workflow to a control apparatus of an automated device; and wherein, the control apparatus performs the workflow that modifies the operation of the automated device.

In another preferred embodiment, automated device is in the form of a manufacturing device. In another preferred embodiment, the automated device is in the form of a machining device. In another preferred embodiment, the automated device is in the form of a robotic transport device or a movable robotic device.

In another preferred embodiment, the automated device is in the form of a manufacturing device having a conveyor, a loading station having a loading mechanism for placing objects in their proper position on the conveyor forming an object stream and an unloading station having an unloading mechanism for removing the objects from the conveyor; wherein, the one or more image capture apparatus comprises one or more cameras position to capture images of the conveyor, and/or the loading station and/or said unloading station and/or the object stream of the automated device and wherein, the captured images are used to identify an event; wherein, if the event is a recognized event, the response software transmits a workflow to the analysis software that modifies the operation of the automated device; and wherein, depending on the recognized event and the concern level, the workflow stops operation of the automated device, or adjust the speed of the conveyor; or directs the object stream to different unloading station.

In a preferred embodiment, the automated device is in the form of a machining device; wherein, the automated device includes a fixture for securing a work piece in position for machining; wherein, the captured images are images of the fixture and the work piece mounted to the fixture; and wherein, if the recognized event is a work piece not properly positioned on the fixture for machining, the analysis directs the response software to stop operation of the automated device and/or transmits a notice to a machine operator.

In a preferred embodiment, the automated device is in the form of a machining device; wherein, the automated device includes a safety mechanism on the automated device; wherein, the captured images include images of the safety mechanism and uses the captured images to identify an event; wherein, the analysis software determines if the event is a recognized event; and wherein, if the event is a recognized event and the recognized event is a modification or removal of the safety mechanism the analysis directs the response software to stop operation of the automated device and/or transmits a notice to an administrator. In a preferred embodiment, the analysis software examines pixels of the captured images and compares the pixels of the captured images with pixels of reference images to identify an event in the captured images.

In a preferred embodiment, the analysis software compares changes in the pixels between the captured images and pixels of reference images, if the change in the pixels exceeds a threshold reference, the analysis software directs the response software to determine a workflow based on the concern level for responding to the recognized event and transmits the workflow to the control unit or the control apparatus.

In a preferred embodiment, the captured images are images of a work piece after machining and the analysis software compares changes in the pixels between the captured images and the reference images and uses the change in pixels to determine if a work piece after machining is within design specifications and wherein if the work piece is outside the design specification, the analysis software directs the response software to determine a workflow for responding to the recognized event and transmits the workflow to the control unit or the control apparatus.

In a preferred embodiment, the automated device is in the form of a robotic transport device freely driven along a predefined path having a loading station and an unloading station; wherein, one or more image capture apparatus is mounted on the automated device for capturing images of a location along the predefined path as the automated device travels along the predefined path; wherein, the analysis software continuously monitors the captured images to identify an event and determines if the event is a recognized event; wherein, if the event is a recognized event, the response software transmits a workflow based on the concern level of the recognized event to the the control unit or the control apparatus; wherein, if the concern level is below a concern level threshold, the control apparatus performs the workflow by directing the automated device to stop moving along the predefined path until the recognized event is eliminated or if the concern level is equal to or exceeds the concern level threshold, the control apparatus performs the workflow by directing the automated device to move along a new predefined path. In a preferred embodiment, the response software determines if an individual is needed to perform the workflow, wherein, if it is determined that the individual is needed to perform the workflow, the response software selects one or more qualified individuals from a listing of qualified individuals who are qualified to perform the workflow and transmits the workflow and the concern level to individuals input/output device of each of the one or more selected one or more qualified individuals. Preferably, if the one or more selected qualified individuals are performing other workflows having concern values, the one or more selected qualified individuals perform the workflows in order of the concern values.

In a preferred embodiment, the analysis software identifies an event by examining changes in the pixels, RGB values and patterns of the captured images.

A preferred embodiment of the invention the system for managing workflows for observed events comprises: a control unit; one or more image capture apparatus that captures images at a location and transmits the captured images to the control unit; an automated device having control apparatus that cooperates with the control unit to control the operation of the automated device; wherein, the control unit and/or control apparatus has analysis software that includes Machine Learning Software; wherein, the analysis software continuously monitors the captured images and uses the Machine Learning Software to detect the occurrence of an event, if the analysis software detects an event, the analysis software determines if the detected event is a recognized event; wherein, the analysis software detects the event by comparing pixels between the captured images and reference images; wherein, the analysis software determines a concern level for the recognized event; wherein, the response software determines a workflow to respond to the recognized event based on the concern level; and wherein, the control apparatus performs the workflow by modifying the operation of the automated device.

A preferred embodiment of the system for managing workflows of observed events comprises: a control unit having analysis software having Machine Learning Software and response software; an automated device in the form of a robotic movable device that moves along a predefined path, the automated device having robotic components and a control apparatus, response software and analysis software with Machine Learning Software; one or more image capture apparatus that captures images of a location or of a machine or manufacturing system and transmits the captured images to the control unit; wherein the analysis software of the control unit uses the captured images to detect an event and determine if the event is a recognized event; wherein the response software of the control unit determines a workflow and transmits the workflow to the control apparatus; wherein the response software of the control apparatus uses control commands to move the automated device to the location or to the machine or manufacturing system and directs the automated device to perform the workflow at the location or on the machine or manufacturing system; wherein the automated device has one or more image capture apparatus that captures images and transmits the captured images of the workflow being performed by the automated device at the location or on the machine or manufacturing system; wherein, the analysis software of the automated device uses the captured images to monitor the workflow being performed at the location or on the machine or manufacturing system by the automated device and uses Machine Learning Software to determine robotic control commands to control robotic components performing the workflow.

These and other benefits, advantages, and embodiments of the invention will be apparent from the following description, the accompanying drawings and the appended claims.

### BRIEF DESCRIPTION OF THE DRAWINGS

Features, aspects, and advantages of the present invention will become better understood with regard to the following description, appended claims, and accompanying drawings where:

FIG. 1 is a schematic representation of a system and method for managing workflows (tasks) for identified (observed) events showing at least one image capture apparatus having one or more cameras for obtaining images at a location and transmitting the at least one image to a control unit, the control unit has a memory with one or more databanks and having a processor for operating system software, analysis software and response software;

FIG. 2 is a schematic illustration showing the analysis software identifying one or more recognized events from images and cooperating with response software to transmit a workflow to one or more qualified individuals or to a robotic or automatic control system controlling a machine or machining or an industrial operation;

FIG. 3 is a schematic illustration showing the control unit in communication with an image display device and one or more individual input/output device used by a qualified individual and/or to an administrator;

FIG. 4 is a schematic illustration showing the control unit having location information and communicating with analysis software that compares location information with threshold references and if the location information exceeds a threshold level, a warning notice is transmitted to individual input/output devices of qualified individuals and/or an alarm notice is transmitted to administrative agencies;

FIG. 5 is a schematic illustration showing the analysis software comparing location information with threshold references and determining if the location information exceeds the threshold reference and if so, the analysis software cooperates with response software that accesses the listing of administrative agencies listed in the agency database and identifies one or more administrative agencies that should receive an alarm notice based on the location information and operates to transmit the alarm notice to the identified administrative agencies;

FIG. 6 is a schematic illustration showing analysis software having Machine Learning Software that receives training information until the Machine Learning Software (AI programming) is trained (trained analysis software) and images or streaming video is fed into the trained analysis software which operates to detect an event or object and communicates with response software to transmit a workflow (task) to one or more individual input/output devices so that a response to the event can be performed;

FIG. 7 is a schematic illustration showing an event being detected by the analysis software and if the event is not a recognized event, the analysis software operates to transmit a notice and an image showing the event to the administrator and the administrator deciding to add the event to the list of recognized events and giving the new recognized event a concern level and adding a workflow for the newly added recognized event to the listing of workflows and identifying qualified individuals on the listing of qualified individuals for responding to the newly added recognized event and further showing the response software operating and using the list of recognized events, listing of workflows and listing of qualified individuals to send a workflow including one or more images showing the newly recognized event to the input/output devices of the identified qualified individuals;

FIG. 8 is a schematic illustration of the system and method of FIGS. 1 and 2 whereby a concern level is assigned to an identified event using a concern level database having a listing of registered events and concern levels for the registered events and a workflow is assigned by response software based on the concern level;

FIG. 9 is a schematic illustration showing the image capture apparatus capturing images and/or a video stream and whereby the control unit stores the images, location information and response information in an event database for future analysis;

FIG. 10 is a schematic illustration showing a control unit having analysis software and response software, a list or recognized events, a concern level database, a workflow databank having a listing of workflows for recognized events, and one or more capture apparatus that captures a plurality of color captured images formed from pixels having a RGB value and the analysis software using the pixels, RGB Values and preferably a time period between captured images to identify a recognized event from the list of recognized events and a concern level from the concern level database and whereby the response software interacts with the analysis software to select a workflow from a listing of workflows;

FIG. 11 is a schematic illustration showing the analysis software calculates the average Pixel RGB value from a color captured image and compares it to a RGB threshold stored in a RGB threshold database and if the average Pixel RGB value exceeds a RGB threshold, the analysis software identifies a recognized event and determines a concern level and interacts with the response software to select and initiate a workflow;

FIG. 12 is a schematic illustration showing the analysis software determining differences in color patterns between a first color ( or monochromatic) collected image and a second color (or monochromatic) collected image and using the change in color (or gray scale) patterns to identify a recognized event and a concern level and the response software identifying a workflow to respond to the recognized event;

FIG. 13 is a flow diagram showing a method of managing workflows for an observed event;

FIG. 14 is a schematic illustration showing a first image capture apparatus capturing a sequence of images showing an event and the analysis software identifying the event as a recognized event and tagging the event as a tagged event, and a second image capture apparatus capturing at least one image and the analysis software identifying an event as a recognized event, and the analysis software using movement information and the sequence of captured images captured by the first image capture analysis to calculate movement of the recognized event to determine if the recognized event captured in the sequence of captured images is the same recognized event identified in the at least one captured image captured by the second image capture apparatus, and if so, giving the second event the same tag as the first event;

FIG. 15 is a schematic illustration showing a first recognized event having attributes and a second recognized event having attributes and analysis software using a comparison of attributes to determine if the first recognized event and the second recognized event are the same recognized event or are different recognized events and if the recognized events are the same, determining if the concern level for the recognized event should be increased or decreased based on the changes in the attributes;

FIG. 16 is a schematic illustration showing the control unit of the system having a memory for storying a plurality of images, an analysis software with Machine Learning Software (AI programming software), whereby a first portion of the plurality of images being tagged for an event by an individual and whereby the tagged first portion is used for training the machine learning software to identify events;

FIG. 17 is a schematic illustration showing an automated device in the form of a manufacturing device having a conveyor and an image capture apparatus that transmits images to a control system having analysis software with Machine Learning Software (AI programming software) that uses transmitted images to detect an event and response software that transmits a workflow to control apparatus of the automated device;

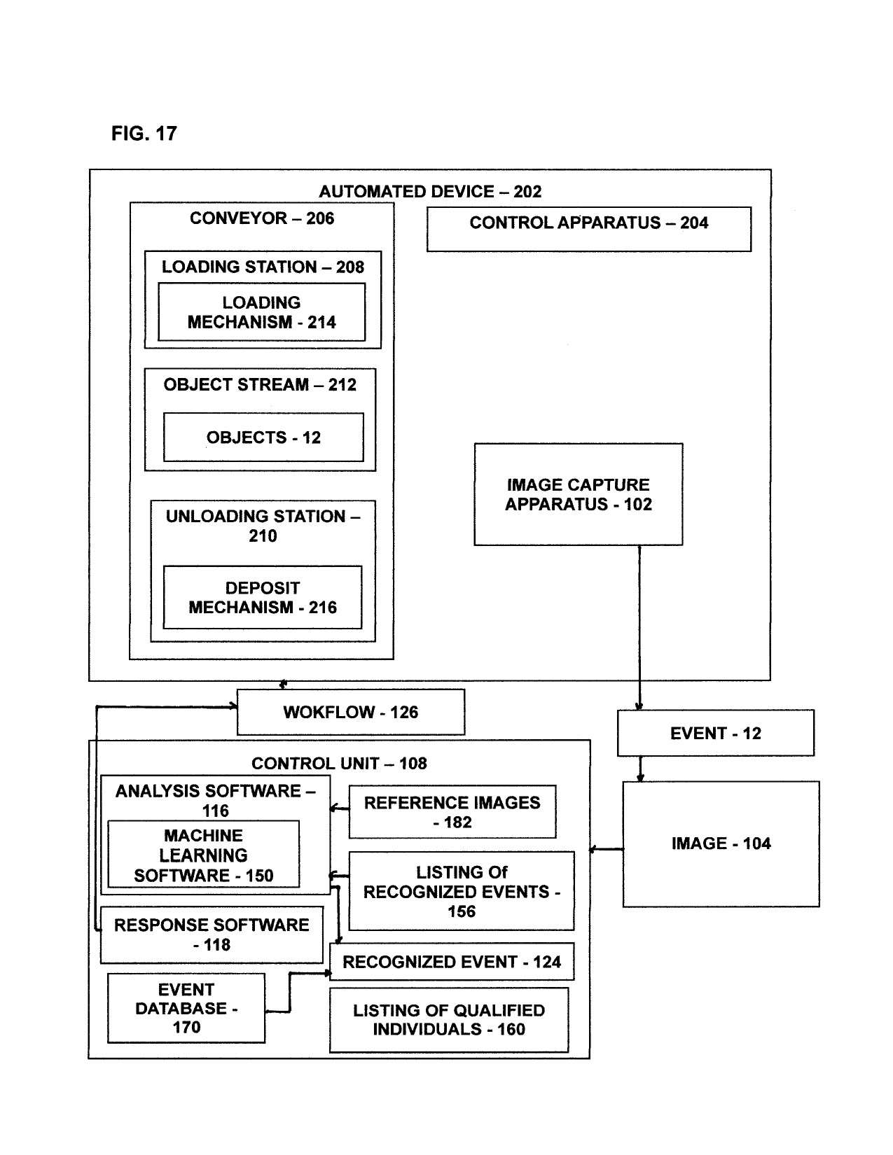

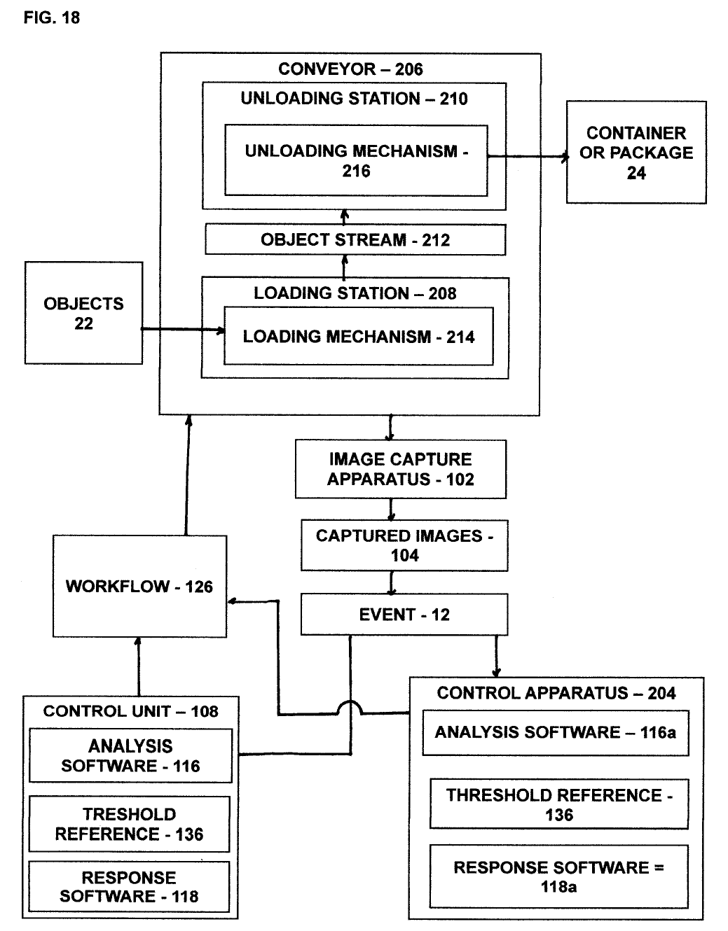

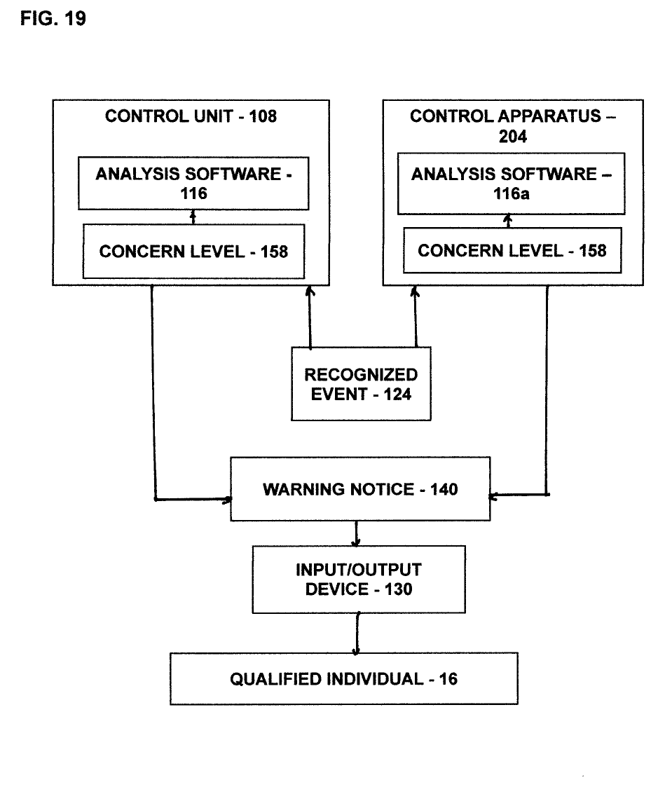

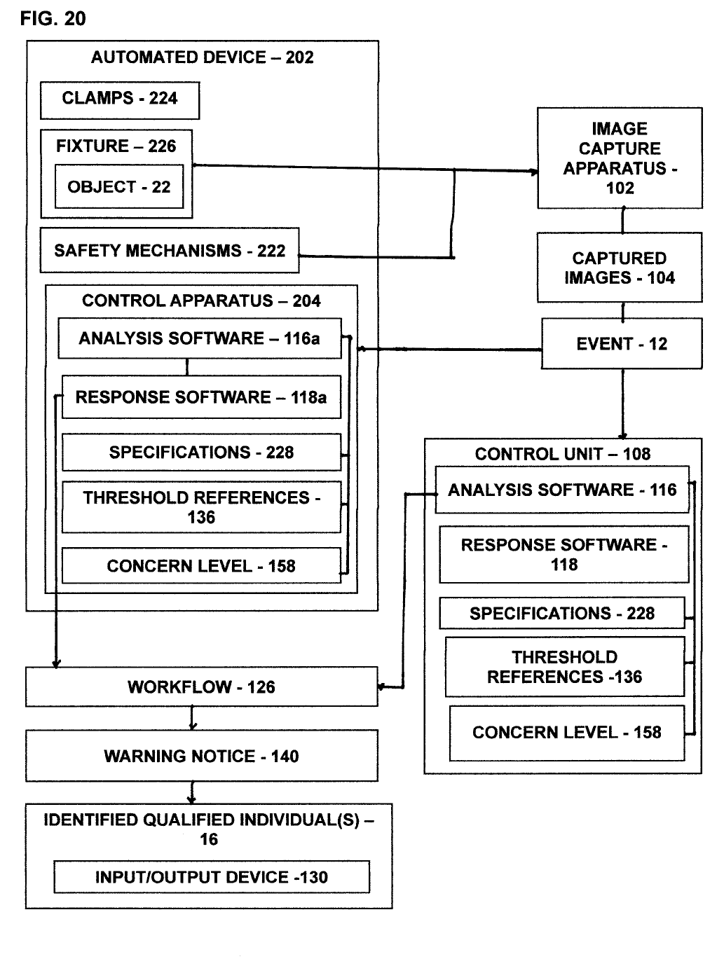

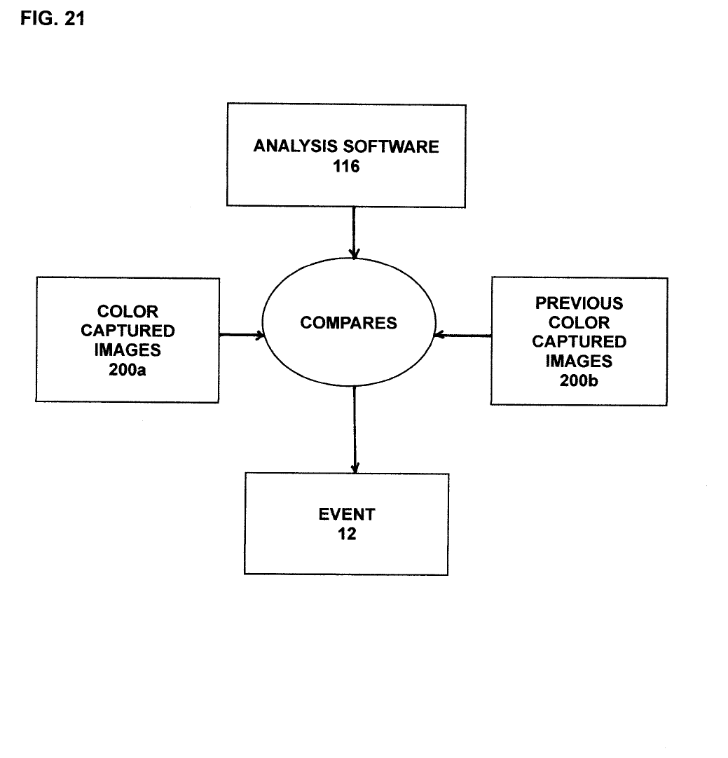

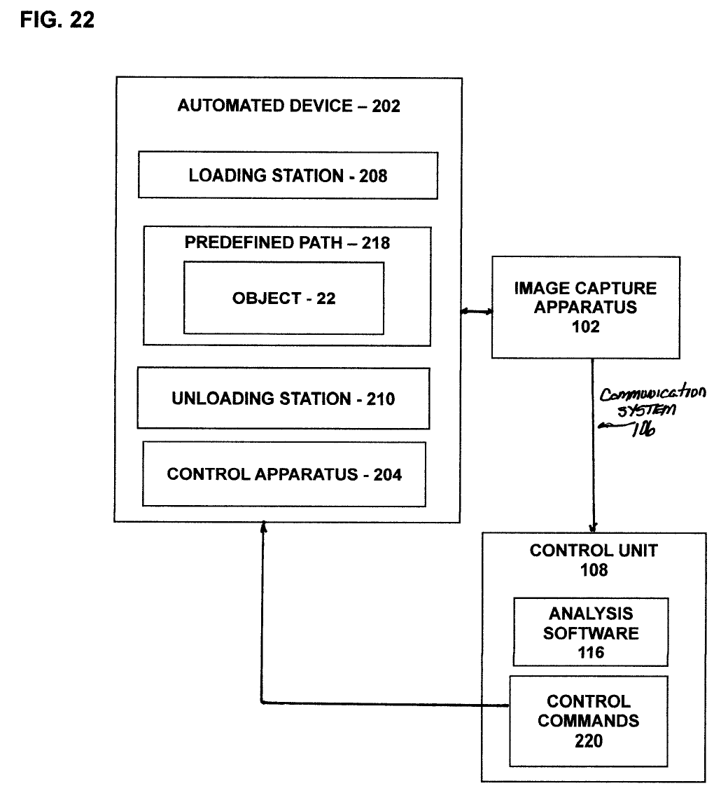

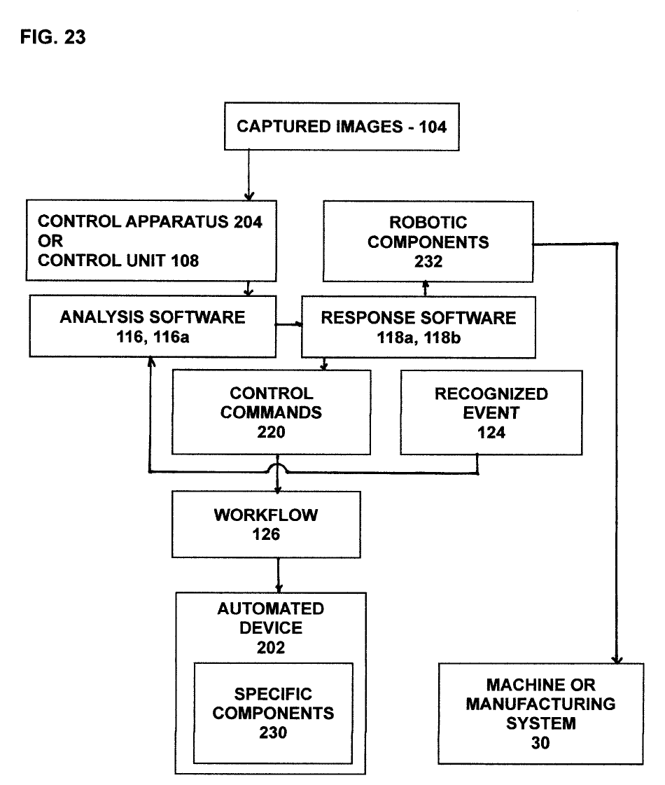

FIG, 18 is a schematic illustration showing the conveyor of of an automated device in the form of a manufacturing device of FIG. 17, whereby the conveyor has an unloading station with an unloading mechanism, a loading station having a loading mechanism and an object stream, whereby one or more image capture apparatus capture images of components of the conveyor and the analysis software of a control unit (central controller) or a control apparatus (control system of the automated device) that identifies an event and uses threshold reference to determine a workflow to be performed by one or more of the conveyor components;

FIG. 19 is a schematic illustration showing a control unit and a control apparatus each having analysis software and a concern level for events whereby a recognized event is given a concern level and a warning notice is transmitted to the input/output device of one or more qualified individuals by said control unit and/or control apparatus;

FIG. 20 is a schematic illustration showing an automated device in the form of a machine device having a fixture for securing an object using clamps, the automated device further has safety mechanisms and a control apparatus or control unit having analysis software, response software, specifications for a formed object, threshold references for use in determining if the object is properly formed by the automated device and a concern level an image capture apparatus that transmits images to the control system or control apparatus that uses transmitted images to detect an event and response software that transmits the workflow and warning notice to one or more qualified individuals;

FIG. 21 is a schematic illustration showing analysis software comparing color (or monochromatic) captured images with previous color (or monochromatic) captured images to identify an event;

FIG. 22 is a schematic illustration showing an automated device in the form of a robotic transport device for transporting an object along a predefined path having a loading station and an unloading station, an image capture apparatus that transmits captured images to a control unit having analysis software and transmits control commands to the automated device; and

FIG. 23 is a schematic illustration showing captured images transmitted to a control apparatus or control unit, analysis software that identifies if an event is a recognized event and if so, control commands and workflow is transmitted to an automated device having various components that perform the workflow on a machine or manufacturing system.

### DETAILED DESCRIPTION OF THE INVENTION

The subject invention is a system and method for managing workflow for observed events. Preferably, the system includes one or more image capture apparatus, such as a camera, that takes images at a location and transmits the images to a control unit having analysis software that operates to monitor the images. If an event is detected, the analysis software operates to determine if the event (or events) is a recognized event and if an event is a recognized event, the analysis software preferably operates to determine a concern value for the recognized event and if the concern value level is of a certain value it directs the control unit to utilize response software that operates to identify one or more individuals qualified to respond to the recognized event and transmits a notification to the one or more identified individuals that a response to the recognized event must be performed.

In describing the preferred embodiments of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose.

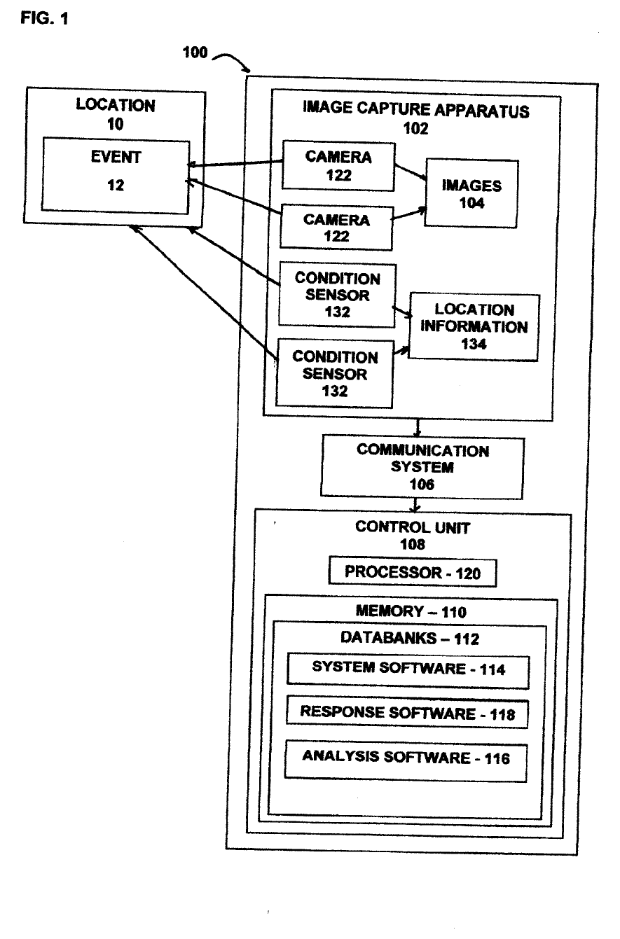

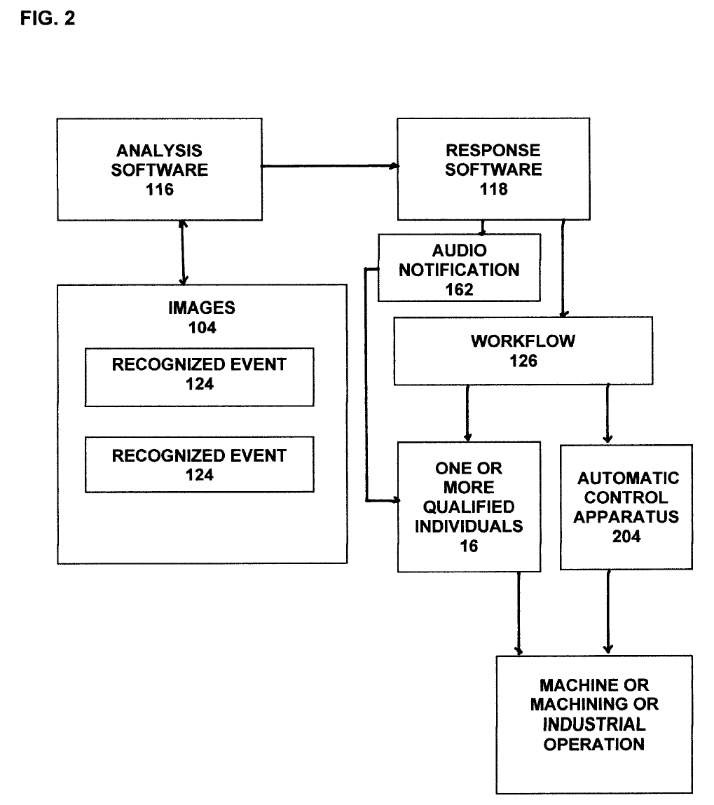

The system and method for managing workflow for observed events 100 of the subject invention is illustrated in FIG. 1, and includes one or more image capture apparatus 102 that operates to capture images (captured images) 104, including individual digital images or a video stream, of a location 10, a communication system 106 that operates to transmit the one or more captured images 104 to a control unit 108. The control unit 108 includes a memory 110 with one or more databanks 112 for storing information and software, including system software 114, analysis software 116, and response software 118, The control unit 108 further includes a processor 120 that operates to implement and operate the software. The image capture apparatus 102 includes one or more cameras 122 that operate to capture one or more images (or video stream) 104 and operates to transmit the captured one or more images (or video stream) 104 through the communication system 106 to the control unit 108. The image capture apparatus 102 can operate such that images (or video stream) are continuously being captured or operates periodically or operates when an event 12 is detected (such as through one or more sensors). Once one or more images 104 is captured and transmitted to the control unit 108, as illustrated in FIG. 2, the analysis software 116 operates to detect and recognize an event (recognized event 124) and communicates with the response software 118 to initiate a response, such as determining or selecting a workflow (task) 126 based on the detected recognized event 124.

As used herein, the term “software” refers to any form of programmed machine-readable language or instructions (e.g., object code) that, when loaded or otherwise installed, provides operating instructions to a machine capable of reading those instructions, such as the control unit or a control apparatus. The system software, analysis software and response software of the present invention can be stored or reside on, as well as be loaded or installed from, one or more floppy disks, CD ROM disks, hard disks or any other form of suitable non-volatile electronic storage media and can also be installed by downloading or other form of remote transmission, such as by using Local or Wide Area Network (LAN or WAN)-based, Internet-based, web-based or other remote downloading or transmission methods. It should be understood that the software can be a single program or can be a combination of existing system software that operate together under a framework to perform the operations described herein. Preferably, the control unit (or control apparatus and described herein below) operates under the control of an operating system, such as the WINDOWS operating system developed by Microsoft Corporation or the MACINTOSH operating system developed by Apple Computer Corporation. It should be understood, however, that other operating systems could be utilized to implement the system software and the analysis software of the present invention. As used herein the term “image”, unless otherwise described, includes individual images, a series of images and/or multiple images and streaming images (video streaming) and can be color images or monochromatic images. As used herein, unless otherwise stated, images can be obtained from a single image capture apparatus or multiple image capture apparatus. As used herein, unless otherwise defined, the term “event” includes various conditions or objects shown in an image. For example, an event can be the location appearance (the location is dark (lights have gone off) or the location becomes lit (lights went on), motion is detected (an object is at a different position within the location), or an object has changed in appearance or color (or gray scale), or an object has appeared at a location or has disappeared from the location) or a change in the environment at the location, such as, but not limited to, water, smoke or fire. The event can also include any objects (including humans) that may appear in one or more images. An event can also include a malfunction of a machine or an error, such as an improper placement of objects or a manufactured object not meeting specifications due to machining errors, and any other occurrences that are detected and unexpected or expected to occur that results in changes in images taken at different times but in the same line of sight.

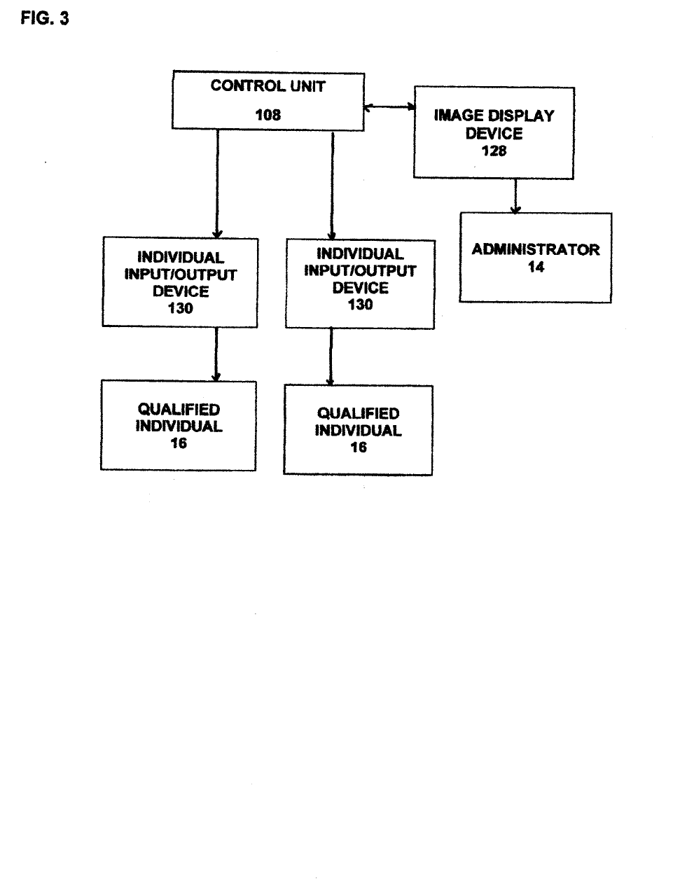

As illustrated in FIG. 1, the image capture apparatus 102 includes one or more cameras 122 that operate to capture one or more digital images or a streaming digital set of images 104 (video stream) at a location 10 and is in communication with the control unit 108 through a communication system 106. As used herein, the term “communication system” can include the Internet, satellite systems, cable systems, telephone systems, television and radio transmission systems, fiber optic systems, microwave systems, asynchronous transfer mode systems, digital subscriber line systems, cellular systems, hardwire systems, and private networks. Referring to FIG. 3, the control unit 108 preferably is in communication with an image display device 128, like a touch screen, or any other suitable device that can accept and display information, such as a display, printer, and the like for receiving and displaying information, such as for review by an administrator 14. The control unit 108 is further in communication to one or more suitable individual input/output devices 130. It should be understood that the control unit can include various combinations of such conventional components, peripherals, and devices. Preferably, the input/output devices 130 are mobile such that an individual can carry the device thereby having access to the device, such as when the individual is at a facility where the location is situated or when the individual is “on call” or when the individual is responsible for performing work or services at the location. Such devices include, but are not limited to, cellular telephones, computers, personal digital assistants (“PDA”), video game consoles, tablets, digital wearable devices, such as smartwatches, and other devices that can be used by an individual in observing the captured images or receiving workflows (tasks) or messages.

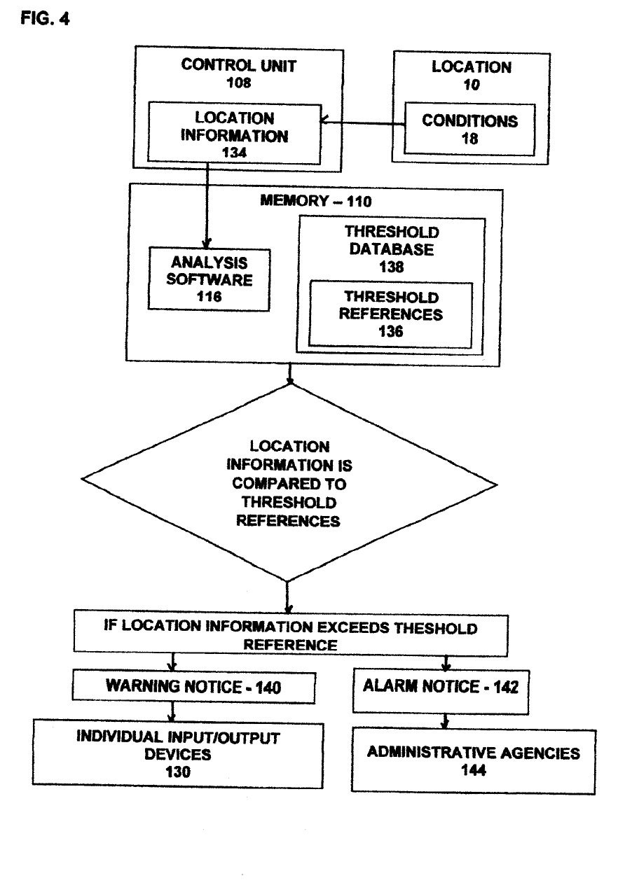

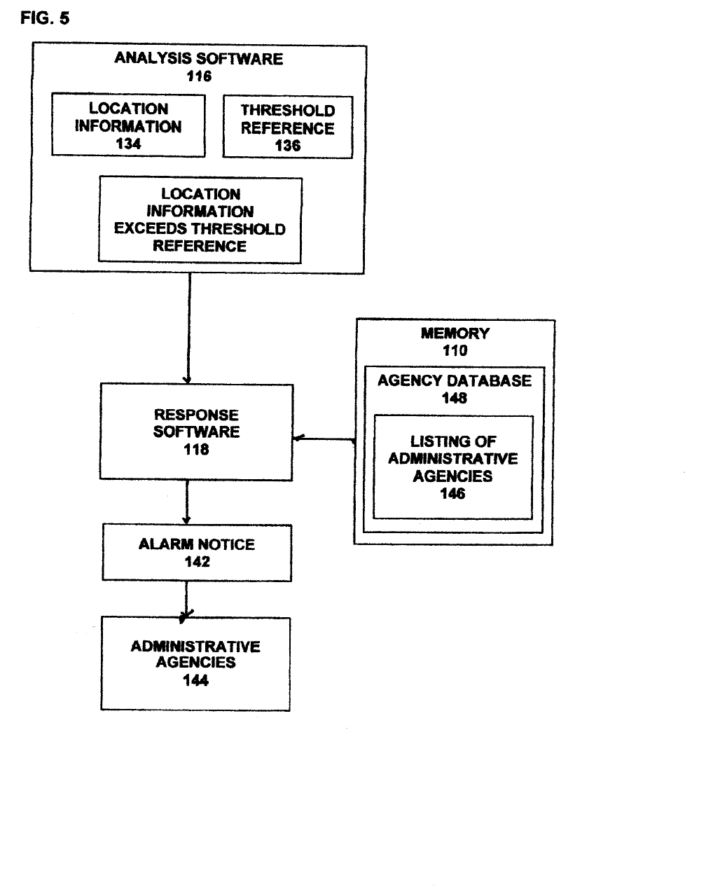

In a preferred embodiment, as illustrated in FIGS. 1 and 4, an image capture apparatus 102 includes one or more condition sensors 132 that operate to obtain location information 134 concerning the conditions 18 at the location 10. The one or more condition sensors 132 may include, but are not limited to, temperature sensors, humidity or water sensors, noise sensors, motion sensors, gas sensors, smoke sensors, and the like, that operate to obtain location information 134 (such as, but not limited to, environmental conditions) and are in communication with the communication system 106 such that the location information 134 is transmitted to the control unit 108. In a preferred embodiment, when the control unit 108 receives location information 134 it operates to direct the analysis software 116 to compare the location information 134 to threshold references 136 stored in a threshold database 138 and if the location information 134 exceeds a pertinent threshold reference 136 for that location, it directs the response software 118 to transmit a warning notice 140 to one or more individuals input/output device 130. Preferably, the response software 118 further operates to transmit one or more images 104 showing the location 10 together with the warning notice 140 thereby allowing the one or more individuals to view the location 10 and better access the condition at the location 10 and the need to perform any corrective measures (workflows). In another preferred embodiment, if the location information 134 at a location 10 exceeds a threshold reference 136, the image capture apparatus 102 at the location 10 operates to transmit captured images 104 of the location 10 to the control unit 108 which directs the analysis software 116 to analyze the images 104 and operate to detect and identify one or more recognized events 124 contained within the captured images 104. In another preferred embodiment of the invention, if the location information 134 exceeds a threshold reference 136, the response software 118 operates to transmit an alarm notice 142 to one or more administrative agencies 144. It should be understood that the alarm notice can be in the form of a text, Email or other similar systems, or to a call in center, such as a 911 operator, or can be tied in directly to an alarm system at the administrative agency. In another preferred embodiment of the invention, as illustrated in FIG. 5, if the location information 134 exceeds a threshold reference 136, the response software 118 operates to identify one or more appropriate administrative agencies 144, such as by utilizing a listing of administrative agencies 146 stored in an agency database 148 that correspond to recognized events and transmits an alarm notice 142 to the identified one or more administrative agencies 144.

### Machine Learning Software

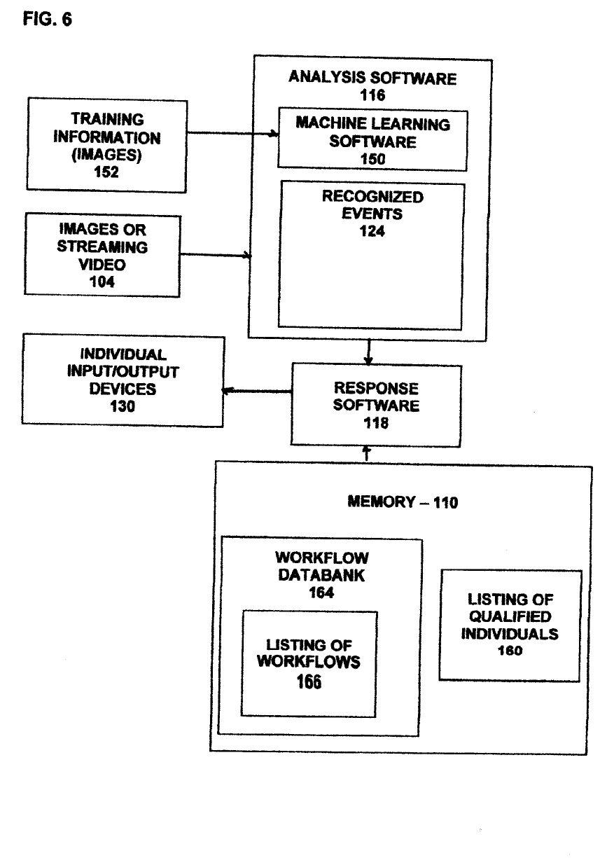

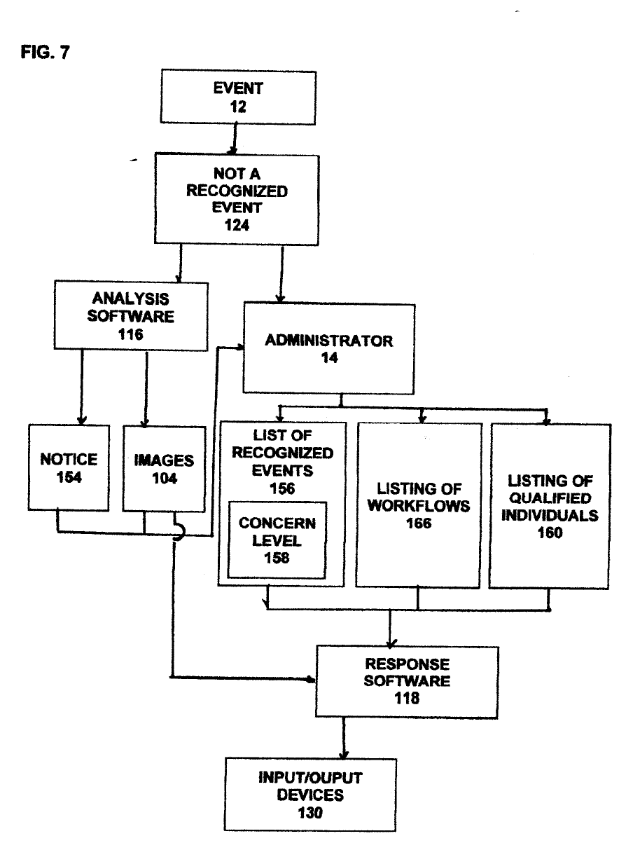

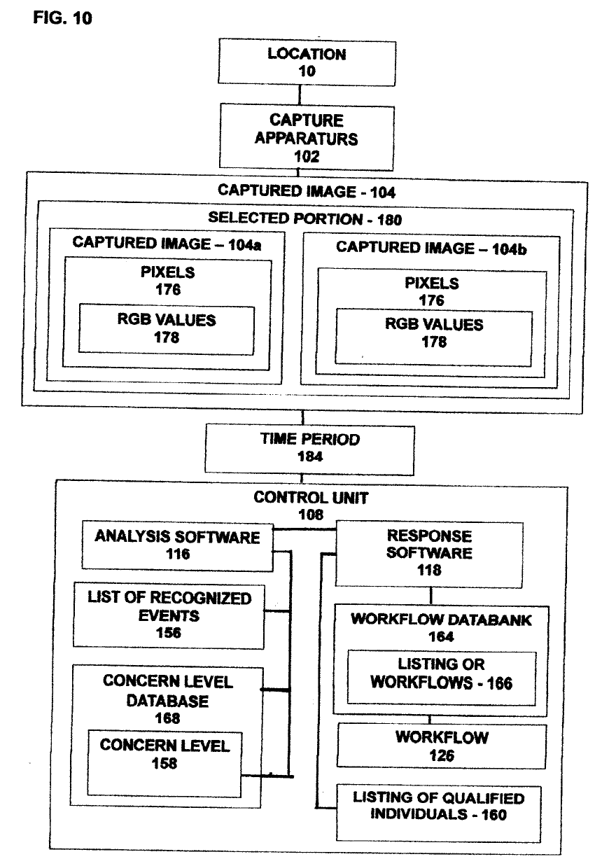

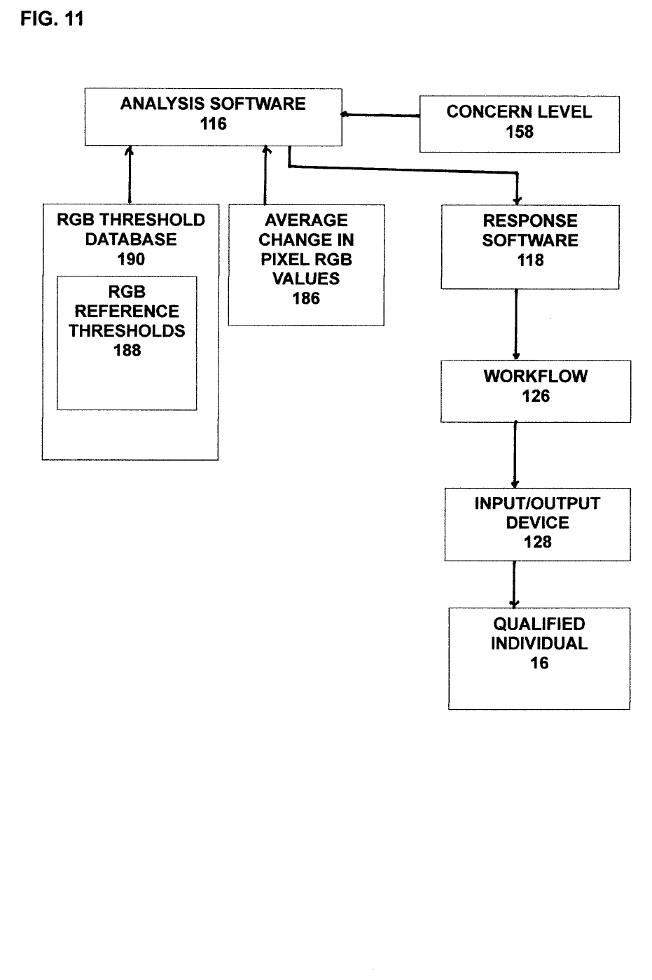

As illustrated in FIG. 6, the analysis software 116 includes conventional Machine Learning Software (MLS) 150 (AI programming) that uses training information (data) 152 that allows the MLS 150 to create neural networks that possess all of the pixels 176 (FIG. 10) that make up images 104 and are presented with training information 152 having multiple images of events that have been identified (recognized events 124), such as manually by individuals placing boxes around each event and event (tagging), so that the networks can learn and recognize similar events and can detect patterns in the training material allowing the MLS to identify other patterns and make determinations automatically. Thus, in operation, once a plurality of images containing events have been tagged and are now recognized events 124, an underlying Deep Neural Network analyzes the images for various patterns from the numerous combinations of pixels on the images and the trained MLS 150 operates in a statistically and acceptable manner to automatically detect and identify recognized events 124 (what it is “trained” to detect). It should be understood that numerous MLS systems have been developed and one skilled in the art can select the MLS system that is best suited for analyzing images and events contained therein based on the particular use of the images. It should also be understood that recognized events 124 should be under various lighting conditions and should be seen in various angles of view as would be recorded by the image captured apparatus at the location. As illustrated in FIG. 7, If an event 12 is not a recognized event 124, the analysis software 116 operates to transmit a notice 154 to an administrator 14 that an event 12 that is not a recognized event 124 has been detected. The administrator 14 can then determine if a workflow 126 (FIG. 2) should be listed in the listing of workflows 166, and if so, the response software 118 operates to use the newly added workflow 126 and identifies one or more qualified individuals 16 from the listing of qualified individuals 160 and transmits the workflow 126 to the individuals input/output devices 130. Further, if the event 12 is not a recognized event 124 the analysis software 116 operates to transmit a notice 154 and one or more of the images 104 to the administrator 14 whereby the administrator 14 can add the event to a list of recognized events 156 (making the event 12 a recognized event 124) and assign a concern level 158 to the new recognized event. The response software 118 can then operate to identify one or more qualified individuals 16 to respond to the new recognized event, such as by accessing the listing of qualified individuals 160 stored in the memory 110 and transmits a workflow 126 and preferably images 104 of the event 12 to the individual input/output devices 130 of the one or more identified qualified individuals 16 in response to the new recognized event 124. It should be understood that the one or more qualified individuals may be individuals that have been assigned, such as listed on the listing of qualified individuals who are “qualified” for responding to unrecognized events. Such qualified individuals can then review the event, such as images, and determine a workflow to handle such a new previously unrecognized event and the individuals to respond. It should be understood that if the event is one that there is a great urgency, such as a condition sensor indicates a serious concern, such as detection of fire or smoke or an injury, or where an image shows a serious concern, the event can be handled immediately before the event is converted to a recognized event (a higher concern level 158 that other recognized events). In a preferred embodiment, the analysis software 116 cooperates with the response software 118 that are recognized events 124 detected and identified by the analysis software 116 causes the analysis software 116 to direct the response software 118 to transmit a workflow 126 to one or more identified qualified individuals 16, the transmitted workflow 126 includes one or more images 104 showing the recognized event 124. In another preferred embodiment, the analysis software 116 operates to identify (highlight) the recognized event 124 shown in the one or more images 104 that is being transmitted with the workflow 126. It should be understood that the workflow 126 being transmitted to the individual input/output devices 130 of the one or more identified qualified individuals 16 can include audio, such as an audio description of the recognized event and concern level (such as expressed audio by the administrator) as well as an audio notification that a workflow 126 has been transmitted to the individual’s input/output device 130.

In a preferred embodiment of the invention, the analysis software 116 operates to continuously (or periodically) analyze the images 104 being transmitted to the control unit 108 (and/or to a control apparatus as described herein below) to identify recognized events 124. When a recognized event 124 has been detected, the analysis software 116 operates to direct the response software 118 to communicate with a workflow databank 164 stored in the memory 110 which contains a listing of workflows (tasks) 166 each corresponding to a different identified recognized event 124. For a non-limiting illustration, If the analysis software detects that a person has entered a location (an event), the analysis software operates to identify the event as a recognized event and directs to response software to access the workflow databank and select a workflow (task) that corresponds to the recognized event. The response software can then access the listing of qualified individuals, that includes a listing of their qualifications, work schedules and other pertinent information, and then operates to identify and transmits a workflow to the one or more individuals that are qualified, based on their qualifications (interacting with the person who entered the location). For another non-limiting illustration, if a box or container (an object) has been moved to a location and is detected and identified by the analysis software as a recognized event, the response software is directed to access the listing of qualified individuals and identify one or more qualified individuals, such as a forklift operator or a machinist or the like, and sends a workflow (such as a notice) to the one or more qualified individuals that a box or container has arrived and needs to be picked up and moved or there is an event occurring at a manufacturing device or machining device.

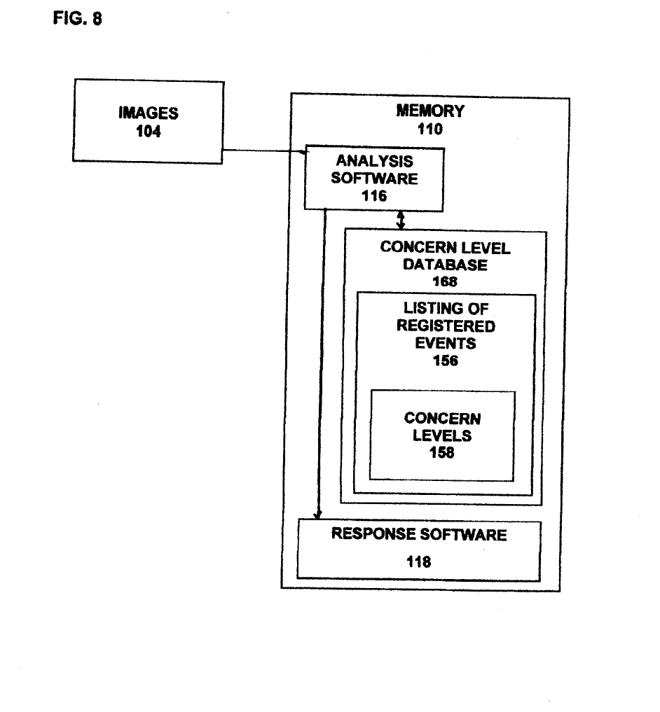

In a preferred embodiment of the invention, as illustrated in FIG. 8, the memory 110 includes a concern level database 168 having a listing of various recognized events 124 each having a concern level 158. In operation, the analysis software 116 operates to continuously (or periodically) analyze the captured images 104 being transmitted to the control unit 108 (or the control apparatus as described herein below) to identify events 12 and registered events 124 contained therein. It should be understood that the analysis software operates automatically when captured images are received from one or more image capture apparatus. Thus, multiple events can be identified in the same images. For a non-limiting illustration, if the analysis software detects and identifies a recognized event (such as an object or smoke at a location), the analysis software accesses the concern level database and identifies the concern level for the identified recognized event. Thus, the analysis software operates to identify the recognized event and a concern level for the recognized event. In a preferred embodiment, the analysis software then directs the response software to access the listing of qualified individuals and identifies one or more qualified individuals, such as security officers, that are qualified for responding to the recognized event and sends a workflow to the one or more qualified individual’s input/output device that a recognized event has been detected. In a preferred embodiment, if the concern level for the recognized event is significant (the concern level is high enough that the transmitted workflow should performed expediently or immediately or within a predetermined amount of time as indicated in the workflow) to mitigate the impact of the event. Thus, the one or more qualified individuals will be aware of the urgency (concern level) of the event and can react accordingly (for example, stop performing a workflow for a lower concern level event and begin working on a workflow for the higher concern level event). In another preferred embodiment, if the concern level is of a certain level, the response software can operate to transmit an alarm to an external administrative agency, such as a fire station or police station. For a non-limiting illustration, if the recognized event is smoke at a location, the analysis software directs the response software to access the workflow databank and depending on the concern level can operate to transmit an alarm notice to one or more administrative agencies, such as a police station or a fire station, that smoke has been detected at a location. In another non-limiting illustration, the analysis software operates to detect and identify an event as a recognized event having a concern level. Depending on the concern level for the recognized event, the analysis software operates to direct the response software to select the proper workflow (task) and transmits the workflow to one or more qualified individuals. In another non-limiting illustration, depending on the recognized event, the response software can send a workflow that modifies the operation of an automated device.

In another preferred embodiment of the invention, the analysis software 116 operates to detect multiple recognized events 124 in a sequence of images 104. The analysis software 116 can then operate to access the list of recognized events 156 that includes recognized events 124 in the form of sequence of events, wherein the sequence includes a concern level 158 associated with particular sequence that the recognized events occurred or the time period 184 between the sequence of the recognized events or the time duration of the sequence of recognized events. For a non-limiting illustration, if a customer enters a location, such as a retail establishment, the analysis software operates to identify the customer as a recognized event (event 1). A store cashier is a second recognized event (event 2). Since a cashier (event 2) should have been identified before the customer (event 1) (recognized event 2 should have occurred prior to recognized event 1), the time sequence of the events would result in the recognized events having a high concern level, thus a notice to an administrator can be transmitted for future analysis and new procedures implemented. In another non-limiting illustration, a customer enters a location, such as a retail establishment, the analysis software operates to identify the customer as a recognized event (event 1) and can use the images to determine that the customer (event 1) has not changed in the images (has remained at the same place for a certain period of time) before the analysis software detects a sales clerk as a recognized event (event 2). The analysis software can operate to use the time period between the recognized events which the sequence would be listed as having a high concern level, thus a notice can be transmitted to an administrator. Further, if the recognized event (event 1) is detected but after a certain amount of time no recognized event (event 2) has been detected, the concern level would be high and a workflow (task) can be sent to other identified qualified individuals (other sales clerks) to attend to the customer. In another non-limiting illustration, the location is a manufacturing location and a worker, detected and identified as a recognized event (event 1) by the analysis software, is working on a product, detected and identified as a recognized event (event 2) by the analysis software. If the analysis software determines that the worker has remained working on the product for a time period that exceeds a threshold reference, the sequence would have a high concern level. Accordingly, a notice can be sent to an administrator and a workflow can be transmitted to other identified qualified individuals that the work is slower than required and that the worker needs assistance. In a non-limiting example, if the analysis software determines that there is an event with an automated device, such as a manufacturing device, the analysis software can determine the cause of the event and send a workflow to a qualified individual to respond to the event or can transmit a workflow to the control apparatus of the device that modifies the programming or operation of the device. Accordingly, it should now be apparent that the analysis software can operate to monitor and analyze images and detect and identify events as well as analyzing event sequences and time between events that can be used to assign workflows (tasks) that will resolve issues, minimize risk, and increase the efficiency of various types of operations.

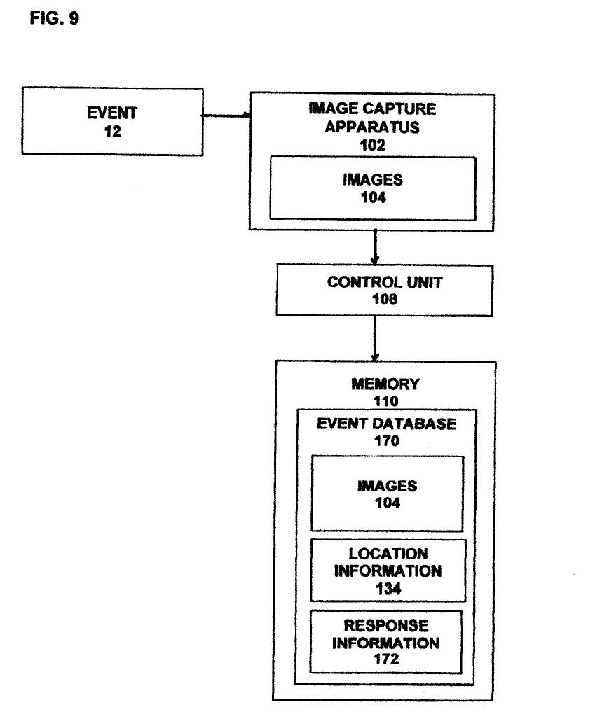

In a preferred embodiment of the invention, as illustrated in FIG. 9, when an event 12 is detected by the image capture apparatus 102, or by a condition sensor 132 (FIG. 1), the image capture apparatus 102 automatically operates to capture images 104 and transmits the images 104 to the control unit 108 which stores the images 104 in an event database 170 in the memory 110 and records the location information 134, such as the specific location, location conditions, time frames, and any other pertinent information and stores the location information 134 in the event database 170. The control unit 108 further operates to monitor and records and stores response information 172 in the event database 170, such as the individuals notified, the time of any notifications, warnings, etc., administrative agencies notified and the time of such notifications, response (workflow) implemented, the time frame that the workflow(s) was performed, and other pertinent information. It should now be apparent that the response information 172 can then be utilized in determining the effectiveness of the workflow, the productivity of the individuals performing the workflow and if improvements or modifications need to be made to the workflow(s) responding to an event.

It should now be apparent that the system and method for managing workflow for observed events can be used to monitor conditions at various locations. Such events can include, but not limited to, the arrival of customers or objects, the detection of unauthorized individuals entering a location, a condition (such as smoke, water, or fire, etc., taking place at a location), and the arrive of an object at a location, etc. It should also now be apparent that events at a location can also be monitored and detect certain events, such as an individual being injured (such as by falling, or acting inconsistent, i.e., lying on the floor) to recognized behavior and an appropriate response (workflow) can be transmitted to a qualified individual. It should also now be apparent that the system and method of the subject invention can also be used for use in manufacturing. For a non-limiting illustration, if a machining operation is to occur in a series of steps (events), the system can operate to detect that a procedure (response or workflow) for a manufacturing step has been performed and has been performed properly or at an appropriate time. If not, a qualified individual can be identified and notified or a new workflow can be implemented to correct a problem and mitigate any undesired consequence. In another non-limiting illustration, it should be apparent that if an event is detected and other events are detected at a later time period, the system can be utilized to determine if any of the detected events are related and, if so, the analysis software can operate to determine how the events are related which can result in more effective workflows (procedures) to be put into effect to avoid future problems and difficulties or correct manufacturing or machining operations to reduce the likelihood of such events.

It should now be apparent that the subject invention is a system and method for managing workflow for observed events. Preferably, the system includes one or more image capture apparatus that takes images at a location and transmits the images to a control unit (or control apparatus as described herein below) having analysis software that operates to monitor the images and if an event is detected it automatically operates to determine if the event is a recognized event and if the event is a recognized event the analysis software operates to direct the control unit (or control apparatus as described herein below) to utilize the response software that operates to identify one or more individuals qualified to respond to the event and transmits a notification (workflow) to the one or more individuals that a response to the event must be performed and/or directs a workflow to the control apparatus of an automatic device to respond to the event. The system further operates to identify a concern level for an event and uses the concern level to determine a response and depending on the concern level, a notice or alarm can be sent one or more individuals qualified for perform the response and can further to one or more administrative agencies.

In a preferred embodiment of the invention, if the event is not a recognized event, the analysis software operates to transmit a notice and one or more of the images to an administrator and whereby the administrator can identify the event as a recognized event and provide it with a concern level and whereby the response software can operate to identify one or more individuals qualified to respond to the new recognized event and can transmits a notification (workflow) to the one or more qualified individuals that a response to the new recognized event must be performed.

In a preferred embodiment of the invention, if a recognized event has been detected and if the concern level is of a specific level, the response software operates to transmit an alarm notice to one or more administrative agencies.

In another preferred embodiment of the invention, if the concern level is of a specific level, the response software uses the event to identify the one or more administrative agencies and the response software will further operate to transmit an alarm notice to the identified one or more administrative agencies.

In another preferred embodiment of the invention, the one or more image capture apparatus includes or cooperates with one or more condition sensors that operate to monitor conditions at the location and uses the conditions at the location to identify a concern value to the event. If the concern level is of a specific level, the response software operates to identify one or more administrative agencies and operates to transmit an alarm notice based on the event and the concern level.

It should now be apparent that the system and method of the subject invention operates such that conditions at various locations are continuously or periodically monitored and when an event of interest is detected, the system operates to determine if it is an actionable recognized event and if so, the system automatically identifies the event and can notify management and/or identifies and notifies a qualified individual or a number of qualified individuals and assigns workflows with regard to the event. Further, the system and method operate to detect and identified events having assigned concern levels that can be used to assign workflows and depending on the concern level can prioritized the workflows.

### Identifying Recognized Events Using Color (or Gray Shading)

In another preferred embodiment, as illustrated in FIGS. 10 and 11. the one or more image captured apparatus 102, the images are in the form of color images (or monochromic), at a location 10 and transmits the captured images 104 to the control unit 108. It should be understood that the images can include an object, such as a room, an outside area, an article (such as a machine, equipment), a part (such a part of a machine or equipment, or a portion of a machine or equipment, a surface, a shelf, an object or other similar structures and devices). The one or more image captured apparatus 102 preferably are visible light cameras capable of taking images of shape, form and color (or shading, such as shades of gray) of objects. The analysis software 116 utilizes a color (or monochromic) captured image 104 by examining pixels 176 and the RGB values (color or gray values) 178 creating the color (or monochromic) captured image 104. The analysis software 116 analyzes the pixels 176 and the pixels RGB values 178 of the color (or monochromic) captured image 104, preferably, for a selected portion 180 of the color (or monochromic) captured image 104, and detects any changes in the pixels 176 and their RGB values 178 occurring between a current color (or monochromic) captured image 104a to a previously (or reference) color (or monochromic) captured image 104b to identify a recognized event 124 (a detected color or gray shaded change). The analysis software 116 then compares the recognized event 124 with a list of recognized events 156 (baseline color or shaded gray changes) to identify the recognized event 124. The analysis software 116 then communicates with the response software 118 to identify a workflow 126, such as by use of a list of workflows 166, and initiate the response (workflow) 126 based on the identified recognized event 124. Preferably, the selected workflow 126 is based on the degree or the color change (the amount of color or shaded gray change, such as the change in the RGB values) to select the proper workflow 126. In a preferred embodiment, the analysis software 116 determines a time period 184 between the color (or monochromic) captured image 104a and the previous color (or monochromic) captured image 104b and communicates with the response software 118 to initiate a response (workflow) 126 based on the identified recognized event 124 and the time period 184. In a preferred embodiment, based on the identified recognized event 124 and/or based on the identified recognized event 124 and the time period 184, the analysis software 116 determines a concern level 158. Preferably, the concern level 158 is based on the degree of color (or gray scale) change. In a preferred embodiment, the analysis software 116 then directs the response software 118 to access a listing of qualified individuals 160 and identifies one or more individuals (qualified individual(s) 16) that are qualified for performing the response (workflow) 126 and sends the workflow 126 and the concern level 158 to the one or more identified qualified individual’s input/output device 130 that a recognized event 124 has been identified and a workflow 126 needs to be performed. In a preferred embodiment, as shown in FIGS. 10 and 11, the analysis software 116 compares the average RGB value 186 of the pixel’s RGB values 178 to RGB reference thresholds 188 stored in a RGB threshold database 190 stored in the memory 110. If the average RGB value 186 is below a reference RGB reference threshold 188 for the recognized event 124, the analysis software 116 reduces the concern level 158 for the workflow 126 and continues to monitor the changes in the pixel’s RGB value 178 until the average RGB value 186 of the pixel’s RGB values 178 becomes greater than the RGB reference threshold 188 for the recognized event 124. Once the average RGB value 186 in the pixels’ RGB values exceeds the RGB reference threshold 188 for the recognized event 124, the analysis software 116 then compares the recognized event 124 with a list of recognized events 156 (baseline color or gray changes). The analysis software 116 then communicates with the response software 118 to identify a workflow 126 initiate a response (workflow) 126 based on the identified recognized event 124.

For a non-limiting illustration, one or more image capture apparatus takes color images of working equipment and transmits the color captured images to the control (or control apparatus as described herein below) unit. The analysis software monitors the color captured images by examining the pixels of the each color captured image and determines if there is a change in the pixel’s RGB values or the average change of the pixel’s RGB values between a first image and a previous time acquired color captured image, such as for example if a hot spot forms on a machine that produces a color change on an object or an automatic device or a part dislocates causing a color change or the output of the equipment (products change in appearance causing a color change), and if there is such a change, a recognized event is then identified and a response is initiated. Another non-limiting illustration, one or more image captured apparatus takes color images of a container, such as a waste disposal container or a store shelf, and transmits the color captured images to the control unit. The analysis software monitors the color captured images by examining the pixels of the each color captured image and determines if there is a change in the pixels’ values (or a change in the average color pixel value) between a first color captured image and a previous time acquired color captured image, such as for example if there a store shelf containing products becomes empty with products thereby producing a color change, if there is such a change a recognized event is identified and a response is initiated. For another non-limiting illustration, one or more image capture apparatus takes color (or monochromic) images of a surface (such as for a non-limiting example, a floor, carpet, table, driveway, sidewalk), and transmits the captured images to the control unit. The analysis software monitors the captured images by examining the pixels of the each captured image and determines if there is a change in the pixels’ values between a first captured image and a previous time acquired captured image or if the average pixels value between the first captured image and a previous later time acquired captured image changes (such as for a non-limiting example if there is water, snow, ice, product pill, or newly placed objects or substance on the surface), that produces a color (or gray scale) change, if there is such a change, a recognized event is identified and a response is initiated. Preferably, the selected workflow is based on the degree or the color (or gray scale) change (the amount of change, such as the change in the RGB values) to select the proper workflow. For a non-limiting example, if a surface, such as a sidewalk shows a color change indicating that snow has accumulated on the sidewalk, the degree of color change may indicate that the sidewalk is entirely covered and the snow needs to be removed or the degree of color change may indicate that the sidewalk is only partially covered with snow and snow removal is not required.

It should be understood that captured images and the method described above are not limited to color images but can comprise only black and white (monochromic) images that only require one channel of luminosity is required (all RGB values (R = G = B)), thereby resulting in shades of gray that contain a full spectrum of gray tones such that each pixel has a value ranging from 0 (black) to 255 (white), resulting in, on average, 256 shades of gray.

Preferably, after a recognized event 124 has been identified and a workflow 126 and concern level 158 are determined, the response software 118 determines if an individual is or is not required to perform the workflow 126. If the response software 118 determines that the workflow 126 can be performed without the need of an individual, the response software 118 interacts with an automated device 202 (FIG. 20), such as for a machine or a robotic system, that can be utilized to perform the workflow. For a non-limiting example, a movable robotic system may be sent into a hazardous area, such as an area where there is a chemical spill or file, to perform a workflow, such as cleaning a spill or extinguish a fire. If the response software 118 determines that an individual or individuals are needed to perform the workflow 126, the response software 118 uses a listing of qualified individuals 160 and identifies one or more individuals that are qualified for performing the workflow (qualified individuals 16) and sends the workflow 126 (the task to be performed) and the concern level 158 to the input/output devices 130 of the identified one or more qualified individuals 16. It should be understood that the identified qualified individuals will perform workflows in accordance with the concern level of the workflow. For an illustrated example, workflows having higher concern level will be performed before workflows having lower concern levels.

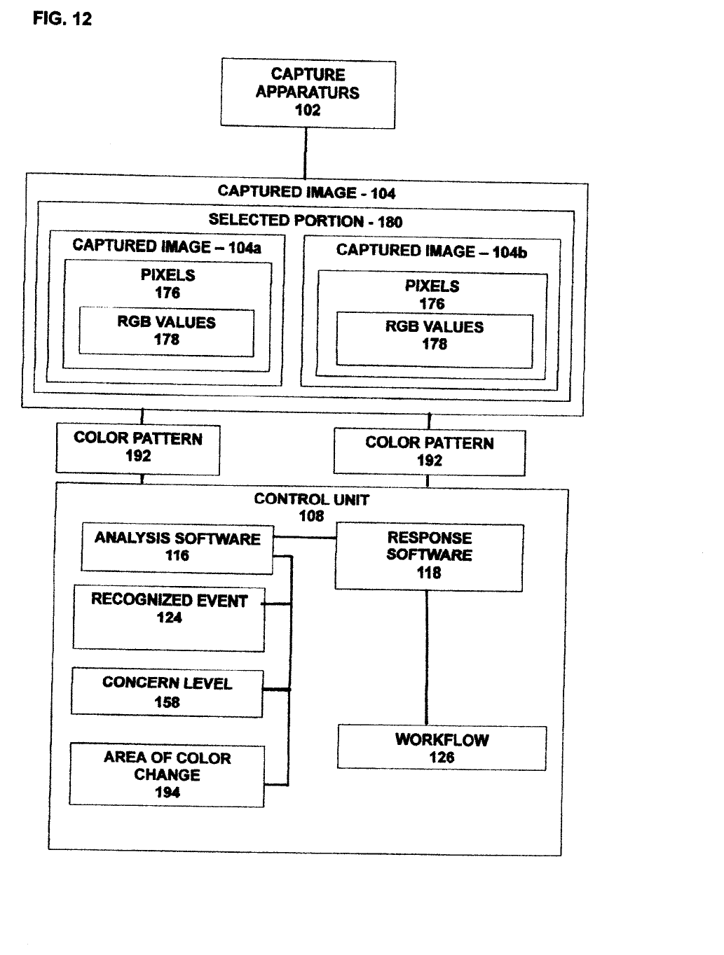

In a preferred embodiment, as illustrated in FIGS. 12 - 14, the analysis software 116 utilizes a color (or monochrome) captured image 104 by examining the pixels 176 creating the image 104 and the pixels RGB values (color values) 178 of the color (or monochrome) captured image 104. The analysis software 116 analyzes the pixels 176 and the pixels RGB values 178 of the captured image 104, preferably, for a selected portion 180 of the captured image 104 and detects any changes in the pixels RGB values 178 that occurred between a first captured image 104a and a previously captured image 104b. The analysis software 116 further identifies changes in color (or monochrome) patterns 192 between the first captured image 104a and the previously captured image 104b. Such image color (or monochromic) pattern variation identification systems are known in the art and are often used to identify changes in color (or gray) patterns in organisms, such as the NI Vision Development Module developed by National Instrument Corp. (Emerson Electric Co, of St. Lois, Missouri). The analysis software 116 uses the changes in pixels RGB values and changes in color (or gray) patterns between the first captured image 104a and the previously captured image 104b to identify a registered event 124. The analysis software 116 then compares the recognized event 124 with a list of recognized events 156 (baseline color changes). The analysis software 116 then communicates with the response software 118 to initiate a response (workflow) 126 based on the recognized event 124.

In another preferred embodiment, the analysis software 116 examines the pixels 176 and the pixels RGB values 178 creating each captured images and detects any changes in the pixels 176 and the pixels RGB values 178 occurring between a first captured image 104a and a previous captured image 104b and calculates the surface area 20 where the changes in color (or shades of gray) occurs. It should also be understood, that in addition to color the system can also analyze color saturation, hue and brightness changes to further identify a recognized event and determine a workflow and concern level for the recognized event.

As described above, in a preferred embodiment of the invention, the system for managing workflows for observed events comprises a control unit having analysis software and response software, one or more image capture apparatus that captures color images at a location and transmits the color captured images to the control unit, a list of or recognized events and a list or workflows for each recognized event in the list of recognized events, wherein the analysis software monitors the color captured images and examines the pixels and compares pixels between a color captured image and a previous color captured image and determines if there is a change between the pixels in the color captured image and the previous color captured image (the pixels in the color captured image are different than the pixels in the previous (an image taken at an earlier time) color captured image), and if there is a change, the analysis software uses a list of recognized events to identify a recognized event and communicates with the response software that uses a listing of workflows to determine a workflow for the identified recognized event. In a preferred embodiment, the analysis software determines if the average RGB value of the pixels creating the color captured image has changed from the average RGB value of the previous color captured image and uses the change in the average RGB values to identify a recognized event from a list of recognized events and communicates with the response software that uses a listing of workflows to determine a workflow for the identified recognized event. In another preferred embodiment, the analysis software identifies changes in color patterns between a color captured image and the previously color captured image. The analysis software uses the changes in pixels RGB values and changes in color patterns between the color captured image and the previously color captured image to identify a registered event. The analysis software then compares the recognized event with a list of recognized events (baseline color pattern changes). The analysis software then communicates with the response software to initiate a response (workflow) based on the recognized event. In another preferred embodiment, the response software further uses the time period between images and the changes in color between images to identify a recognized event and/or to determine a concern level for the identified event.

Preferably, the system 100 further operates such that a concern level 158 identified and a workflow 126 and concern level 158 are determined, the response software 118 determines if an individual is or is not required to perform the workflow. As previously described, if the response software 118 determines that the workflow 126 can be performed without the need of an individual, the response software 118 interacts with an automated device 202 designed to perform the workflow 126. If the response software 118 determines that an individual or individuals are needed to perform the workflow 126, the response software 118 identifies one or more individuals (qualified individuals 16) from a listing of qualified individuals 160 and transmits such workflow 126 to the input/output devices 130 of the identified one or more qualified individuals 16. The qualified individual(s) 16 then perform various workflows 126 in the order of their concern level 158, the higher the concern level the greater the urgency in performing the workflow.

### Identifying a Recognized Event as it Moves Through a Location

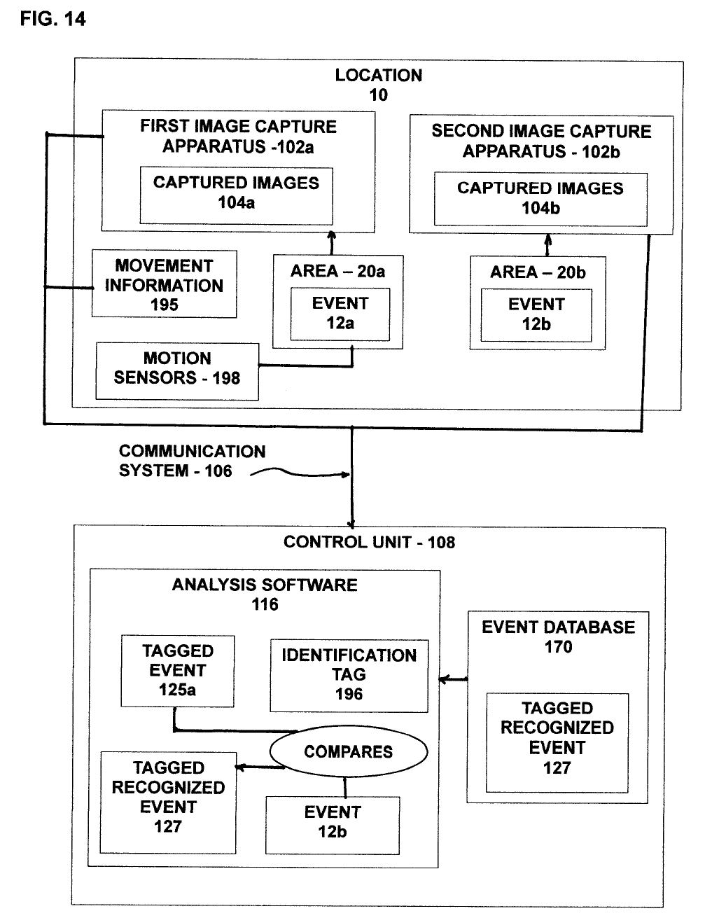

Referring to FIG. 14, in another embodiment of the invention the system and method for managing workflow for an observed event tracks the event as it moves through a location is shown. As illustrated, the system 100 includes two or more image capture apparatus 102 strategically placed to capture images (captured images 104) within the location 10. As further illustrated, a first image capture apparatus 102a captures one or more images (captured images) 104a of an area 20a within a location 10 and transmits the captured images 104a to a control unit 108 using the communication system 106. The control unit 108 has analysis software 116 that continuously monitors the captured images 104a captured by the first image capture apparatus 102a to detect events 12. If an event 12 is detected, the analysis software 116 then calculates movement information 194 of the event 12 using the captured images 104a captured by said first image capture apparatus 102a and assigns an identification tag 196 to the event (tagged event 12a). The tagged event 12a and the identification tag 196 are then saved in event database 170. Preferably, the analysis software 116 then determines, as described above, if the observed tagged event 12a is a recognized event 124. If the observed tagged event 12a is a recognized event 124, it is stored in the event database 170 as a recognized event 124 together with the assigned identification tag 196. Once the event 12a has been detected and tagged, the analysis software 116 uses movement information 194 obtained of the event 12a to acquire or calculate the speed and direction of movement of the tagged event 12a. It should be understood that movement information 194 preferably includes data that permits the direction of movement and speed of movement of the detected tagged event 12a (or tagged recognized event 124) to be directly obtained by the analysis software 116 or can be used to calculate the speed and direction of movement of the tagged event 12a. Such movement information 194 can be obtained using various known techniques and systems, such as by use of various motion sensors 198 positioned within the location 10 that together detect movement and translates the movement into data that is transmitted to the control unit 108 and analyzed and interpreted by the analysis software 116 to obtain or calculate various aspects of the detected tagged event’s movement 12a (or tagged recognized event 124a), such as speed and direction of movement of the tagged event 12a (or tagged recognized event 124). In the preferred embodiment, the system 100 includes a second image capture apparatus 102b that captures one or more images (captured images 104b) of another area 20b of the location 10 and transmits the captured images 104b to the control unit 108. The analysis software 116 continuously monitors the captured images 104b captured by the second image capture apparatus 102b to detect an event 12b. If an event is detected, the analysis software 116 uses the movement information 194 of the tagged event 12a identified in the captured images 104a captured by the first image capture apparatus 102a to determine if the tagged event 12a (or tagged recognized event 124) detected in the captured images 104a captured by the first image capture apparatus 102a is the same event 12b (or recognized event 124) detected in the captured images 104b taken by said second capture apparatus 102b. If the analysis software 116 determines that the tagged event 12a (or tagged recognized event 124) detected in the captured images 104a captured by the first image capture apparatus 102a is the same event 12b (or recognized event 124) detected in the captured images 104b captured by the second image capture apparatus 102b, the event 12b (or tagged recognized event 124) detected in the captured images 104b captured by the second image capture apparatus 102b is assigned the same identification tag 196 as the tagged event 12a (or tagged recognized event 124a) detected in the captured images captured by the first image capture apparatus 102a. If the analysis software 116 determines that the tagged event 12a (or tagged recognized event 124) detected in the captured images 104a captured by the first image capture apparatus 102a is not the same event 12b (or recognized event 124) detected in the captured images 104b captured by the second image capture apparatus 102b, the event 12b (or recognized event 124) detected in the captured images 104b captured by the second image capture apparatus 102b is assigned a different or new identification tag 196. It should now be apparent that the preferred embodiment of the system permits the tracking of an event (or recognized event) as it moves though a location and comes into and out of view by various image capture apparatus and to identify that the event (or recognized event) as being the same event (or same recognized event) as in goes out of view by one image capture apparatus and comes into view by another image capture apparatus. It should also now be understood that an event (or recognized event) can be tracked as it moves through a location without the need of a tracking device attached to the event (such as an object). It should also be understood that an event, whether it is a recognized event or not, can be tracked as it moves through a location.

In a non-limiting illustrative example, if an event, such as an individual walking down a corridor (area) in a location, a first image capture apparatus operates to capture images of the individual which are transmitted, such as by the communications system, to the control unit. The analysis software, using movement information transmitted to the control unit uses the movement information to determine a time which the individual (event) should appear in captured images captured by another (a second) image capture apparatus, such as an image capture apparatus farther down the corridor or an image capture apparatus capturing images at an intersection (another area) of that corridor and another corridor. By using the movement information, the analysis software determines that the individual (event) is the same individual (event) in the images captured by the first image capture apparatus as the individual (event) in the images captured by the another (second) image capture apparatus. For example, using the movement information the analysis software can calculate the time that the individual (event) should appear in the images captured by the second image capture apparatus, and if an individual (event) appears in the images captured by the second image capture apparatus within the calculated time, it is likely the same individual and should be assigned the same identification tag as the individual (event) that appeared in the captured images captured by the first image capture apparatus. It should also be understood, that if the individual (event) is a recognized individual (recognized event), the certainty that the individual (recognized event) is the same individual (recognized event) increases. It should also now be apparent that the same process allows an event to be tracked as it moves throughout a location and comes into view of various image capture apparatus.

In another non-limiting illustrative example, if an event, such as an individual walking down a corridor (area) in a location, a first image capture apparatus operates to capture images of the individual which are transmitted, such as by the communications system, to the control unit. The analysis software, using attributes such as the size, shape, color, color or gray patterns to determine a time which the individual (event) should appear in captured images captured by another (a second) image capture apparatus, such as an image capture apparatus farther down the corridor or an image capture apparatus capturing images at an intersection (another area) of that corridor and another corridor. By using the movement information, the analysis software determines that the individual (event) is the same individual (event) in the images captured by the first image capture apparatus as the individual (event) in the images captured by the another (second) image capture apparatus.

In another preferred embodiment, for each detected tagged recognized event 124, the analysis software 116 determines if the tagged recognized event 124 is a recognized event requiring a workflow 126, as described above, and if the analysis software 116 determines that the tagged event 12 is a recognized event 124 requiring a workflow 126, the analysis event 116 cooperates with response software 118 to transmit the workflow 126 to a qualified individual 16 (as described above) to perform the workflow 126 or directs robotic or automatic device 174 to perform the workflow 126.

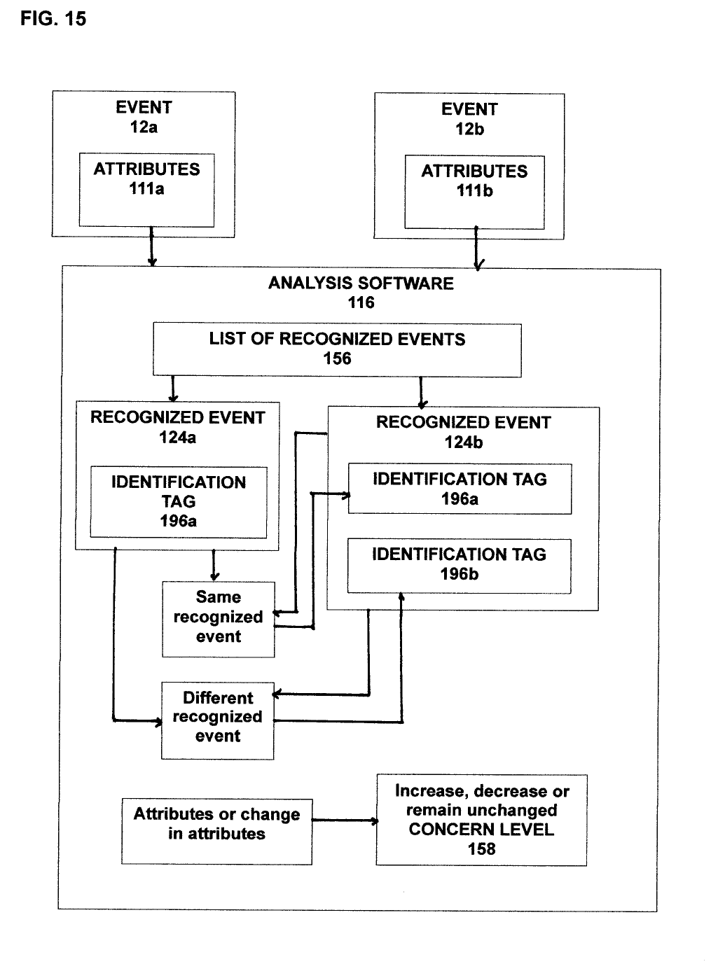

In a preferred embodiment of the invention, if an event 12 is detected, as illustrated in FIG. 15, the analysis software 116 analyzes the captured images 104a to determine if the event 12 is a recognized event 124a, such as comparing the captured images 104a captured in a first image capture apparatus 102a to a list of recognized events 156 (such as by comparing the captured images 104a to reference images 182 that identify a recognized event in the list of recognized events 156) and assigns an identification tag 196a to the recognized event 124a and stores the recognized event 124a (such as by storing the one or more images used to detect the event) in the event database 170 in the memory 110 (or in a cloud). In a preferred embodiment, the analysis software uses a list of recognized events 156, each having a concern level 158, to assign a concern level 158 to the tagged recognized event 124a. Captured images 104b captured by a second image capture apparatus 102b are analyzed by the analysis software 116 to identify an event 12b and uses the list of recognized events 156 to determine if the event 12b is a recognized event 124b and if the recognized event 124b is not the same recognized event 124a it assigns a new identification tag 196b to the recognized event 124b. If the recognized event 124b is the same recognized event 124a it assigns the same identification tag 196a to the recognized event 124b. In a preferred embodiment, the analysis software 116 uses various attributes 111a of the recognized event 124a and the various attributes 111b of the recognized event 124b, such as color, color patterns, size, shape, temperature patterns, motion, direction of movement, speed of movement, dwell time, time duration, time periods, number of times a recognized event is detected, and other attributes, to determine if the recognized events 124a and 124b are the same or different recognized events. In another preferred embodiment, the analysis software 116 determines differences (changes) in the attributes 111a and 111b to adjust the concern level 158 of the recognized event. For a non-limiting illustrative example, if the color or color pattern of the recognized event changes, the analysis software can increase or decrease the concern level for the recognized event. In another non-limiting illustrative example, the direction of movement of recognized event can be used by the analysis software to increase or decrease the concern level, such as if the recognized event is moving closer or away from a hazardous area.

In order to better illustrate a preferred embodiment of the invention, the system includes a first image capture apparatus strategically positioned within a location and takes images (captured images) of an area. The images are transmitted to a control unit using a communication system. The control unit has analysis software that continuously monitors the transmitted captured images and if an event is detected, the analysis software associates an identification tag to the detected event and stores the captured image showing the event together with the assigned identification tag in an event data database. In a preferred embodiment, the analysis software determines if the event is a recognized event. If the event is not a recognized event, the analysis software performs the operations as described above and transmits a notice and one or more of the captured images to an administrator that can add the event to a list of recognized events making the event a recognized event. Other operations, as described above, such as assigning a concern level and a workflow can also be performed. Using various sensors, movement information is transmitted to the control unit using the communication system which is used by the analysis software in determining the movement of the event. The system includes one or more other image capture apparatus that capture images of other areas within the location. Using movement information, the analysis software calculates or determines when the event that was detected is expected to be captured by one or more of the other image captured apparatus (an expected time period) and identifies the one or more image capture apparatus that is expected to capture images showing the event. If an identified image capture apparatus captures an image showing an event within the time period as calculated or determined by the analysis software and the image capture apparatus is an identified image capture apparatus, the analysis software concludes that it is the same event and assigns the event shown in the captured images captured by the identified image capture apparatus the same identification tag as the event. If an event is shown in captured images by an image captured apparatus that is not an identified image capture apparatus or the captured images was captured outside the time period, the analysis software assigns the event a different (new) identification tag. Preferably, the analysis software determines if the event detected in the captured images captured by an identified image capture apparatus is a recognized event which is used by the analysis software in determining if the events taken by the various image capture apparatus are the same events. The analysis software cooperating with response software further assigns a concern level to the recognized event and a workflow and if a workflow is needed, the analysis software and response software further cooperate to implement a response as described above.

Another non-limiting illustration, a first image captured apparatus 102a captures one or more images 104a, preferably color images, and transmits the captured images 104a to the control unit 108. The analysis software 116 continuously monitors the captured images 104a to detect an event 12a. When an event 12a has been detected, the analysis software 116 determines if the event 12a is a recognized event 124a, such as by using various attributes 111 of the event 12a, such as by using the size, shape, color, and color patterns of the event as described above. The analysis software 116, continues to monitor images 104b captured by other image captured apparatus 102b to detect an event 12b and as described above determines if the event 12b is a recognized event 124b. The analysis software 116 using attributes 111, such as the size, shape, color, and color patterns determines that the event 12b is a recognized event 124b and if the recognized event 124b is the same recognized event 124a detected in previous images captured by an image capture apparatus. The analysis software 116 further uses changes in the attributes 111 to determine if the recognized event has changed. For example, if the recognized event detected in images captured by a first image capture apparatus is an individual carrying luggage, such as through an airport, and the same recognized event captured in images captured by a second image capture apparatus has changes in the attributes that the analysis software determines that the individual no longer is carrying luggage, such as by using Machine Learning Software (AI programming), the concern value may be increased and the analysis software cooperating with response software can assign and transmit a workflow to the input/output devices of qualified individuals directing one or more qualified individuals to investigate or monitor the individual or directs other systems, such as conventional security systems to perform a workflow.

It should also now be understood that an event can be in the form of a condition, such as fire, smoke, water, gas and the like. For an illustrated example, the event detected in a capture image captured by a first image captured apparatus may be identified as a recognized event. Movement information (such as direction of movement of smoke, water, fire and the like) of such a recognized event can be calculated or determined and used as described above to identify other image capture apparatus that is expected to capture images showing such event. In this way, the analysis software can calculate or determine the speed that the event is moving (as well as the size of the event – area it covers) and a concern level and workflow can be assigned and a proper response can be implemented.

A preferred embodiment of the system for tracking an event as the event moves through a location is shown in FIG. 14, comprises a first image capture apparatus 102a that captures one or more images 104a at a location and transmits the captured images 104a to a control unit 108, wherein the control unit 108 has analysis software 116 that monitors the captured images 104a captured by the first capture apparatus 102a to detect an event 12a, if an event 12a is detected, the analysis software 116 then calculates movement information 195 using motion sensors 198 of the event 12a captured by the first image apparatus 102a and assigns an identification tag 196 to the event (tagged event 125a); a second image capture apparatus 102b that captures one or more images 104b at a location and transmits the captured images 104b to the control unit 108, wherein the analysis software 116 monitors the captured images 104b captured by the second image capture apparatus 102b to detect an event 12b, if an event 12b is detected, the analysis software 116 uses the movement information 195, using motion sensors 198 to determine if the tagged event 125a detected in the captured images captured 104a by the first image capture apparatus 102a is the same event 12b detected in the captured images 104b taken by the second capture apparatus 102b. If the analysis software 116 determines that the tagged event 125a detected in the captured images 104a captured by the first image capture apparatus 102a is the same event 12b detected in the captured images 104b captured by the second image capture apparatus 102b, the event 12b detected in the captured images 104b captured by the second image capture apparatus 102b is assigned the same identification tag 196 as the tagged event 125 detected in the captured images 104a captured by the first image capture apparatus 102a. If the analysis software determines that the tagged event detected in the captured images captured by the first image capture apparatus is not the same event detected in the captured images captured by the second image capture apparatus, the event detected in the captured images captured by the second image capture apparatus is assigned a different identification tag. For each detected tagged event, the analysis software determines if the tagged event is a recognized event requiring a workflow and if the analysis software determines that a tagged event is a tagged recognized event 127 requiring a workflow, the analysis event cooperates with response software to select a workflow and transmit the workflow to a qualified individual to perform the workflow or directs an automatic device to perform the workflow.

In a preferred embodiment, the analysis software uses movement information of the tagged event in determining if the tagged event is a recognized event that requires a workflow.

In a preferred embodiment, the analysis software determines a concern level for the recognized event.

In a preferred embodiment, the captured images are color images.

In a preferred embodiment, the captured images are color or (monochromic) images and the analysis software determines if there is a color change in the tagged event as it moves through the location and if the analysis software determines that there is a color change, the analysis software uses the color change in determining if the tagged event is a recognized event and if the tagged event is a recognized event, the analysis software assigns a concern level for the recognized event and uses the concern level in determining if the recognized event requires a workflow.

In a preferred embodiment, the captured images captured by the first image capture apparatus and the captured images captured by the second image capture apparatus are color images. If the tagged event detected in the captured images captured by the first image capture apparatus is the same tagged event detected in the captured images captured by the second image capture apparatus, the analysis software then compares the captured images captured by the first image capture apparatus of the tagged event and the captured images captured by the second image capture apparatus of the tagged event to determine if there is a color change in the tagged event as it moves through the location. If the analysis software determines that there is a color change, the analysis software uses the color change in determining a concern value and a workflow for responding to the color change.

In a preferred embodiment, if the analysis software determines that the tagged event requires a workflow, the analysis software communicates with response software to determine if an individual is needed to perform the workflow. If it is determined that an individual is needed to perform the workflow, the response software selects one or more qualified individuals who are qualified to perform the workflow and transmits the workflow to individuals input/output device of each selected one or more qualified individuals. If the response software determines that an individual is not needed to perform the workflow, the response software interacts with one or more control apparatus of automatic devices to perform the workflow.

In a preferred embodiment if the response software determines if an individual is needed to perform the workflow, the response software transmits the concern level to the individuals input/output device and if the one or more qualified individuals are performing other workflows having concern levels, the one or more qualified individuals perform the workflows in order of the concern levels.

In a preferred embodiment, the captured images are color (or monochromic) images, and if the analysis software determines that the event detected in the captured images captured by the first image capture apparats and the event detected in the captured images captured by the second image capture apparatus are the same event, the analysis software examines and compares color pixels and RGB values (color values) creating a portion of a captured image showing the event detected in the captured image captured by the first image capture apparatus to a portion of a captured image showing the event detected in the capture image captured by the second image capture apparatus and uses the comparison to detect any changes in the pixels and RGB values and uses the detected changes in determining if a workflow is required for responding to the event.

In a preferred embodiment, the captured images are color (or monochromic) images, and the analysis software examines pixels and RGB values (color values) and calculates an average RGB value creating the event detected in the captured images captured by the first image capture apparatus and examines pixels and RGB values (color values) and calculates an average RGB value creating the event detected in the captured images captured by the second image capture apparatus and uses the average RGB values to detect any changes in the average RGB values to determine if there is a change in color (or gray shading) between the event detected in the captured images and the analysis software uses the change in color (or gray shading) in determining if an event detected is a recognized event.

In a preferred embodiment, if the event is a recognized event, the analysis software compares the change in said average RGB values with RGB reference thresholds for the recognized event and if the change in the average RGB values is below RGB reference thresholds. The analysis software continues to monitor the captured images, and if the change in average RGB values is equal to or above the RGB reference thresholds, the analysis software determines a concern value and directs the response software to determine a workflow for responding to the recognized event.

In a preferred embodiment, the workflow is further selected based on degree or color change (the amount of color change, such as the change in the RGB values).

In a preferred embodiment, the captured images are color (or monochromic) images and if the analysis software determines that the event detected in the captured images captured by the first image apparatus and the event detected in the captured images captured by the second image capture apparatus are the same event, the analysis software identifies changes in color (or gray shading) patterns between the event detected in the captured images captured by the first image capture apparatus and the event detected in the captured image captured by the second image capture apparatus and uses the change in the color (or gray shading) patterns to determine if the event is a recognized event.

In a preferred embodiment, if the recognized event detected in the captured images captured by the first image capture apparatus and the recognized event detected in the captured images captured by the second image capture apparatus are the same recognized event, the analysis software determines a time period between the captured images captured by the first image capture apparatus showing the recognized event and the captured images captured by the second image capture apparatus showing the recognized event. The analysis software then uses the time period in determining the concern level.

In a preferred embodiment, the recognized event is selected from a list of recognized events that correspond to a color (or gray shading) change.

In a preferred embodiment, the analysis software determines a color change (or gray shading) in the recognized event and calculates a surface area where changes in color (or gray shading) occurs and uses the surface area in determining a concern level.

A preferred embodiment of the invention is a system for tracking an event as the event moves through a location comprising: a first image capture apparatus that captures one or more images at the location and transmits the one or more captured images to a control unit. The control unit has analysis software that monitors the captured images captured by the first image capture apparatus to detect an event having attributes and uses the attributes to determine if the event is a recognized event. If the event is a recognized event, the analysis software assigns an identification tag to the recognized event and a concern level for the recognized event. A second image capture apparatus captures one or more images at the location and transmits the one or more captured images to the control unit. The analysis software monitors the captured images captured by the first image capture apparatus to detect an event having attributes and uses the attributes to determine if the event is a recognized event. The analysis software determines if the recognized event detected in the captured images captured by the first image capture apparatus is the same recognized event detected in the captured images captured by the second image capture apparatus and if the recognized events are the same recognized event, the analysis software assigns the same identification tag to the recognized event detected in the captured images captured by the second image capture apparatus. The analysis software compares the attributes of the events to determine if the concern level should be increased or decreased and assigns the same or an increased or decreased concern level to the recognized event detected in the captured images captured by the second image capture apparatus. The analysis software cooperates with response software to determine if the same recognized event requires a workflow, and if the same recognized event requires a workflow, the analysis software cooperates with response software to select a workflow and transmits the workflow to a qualified individual to perform the workflow or directs automatic devices to perform the workflow.

In a preferred embodiment, if the workflow is to be performed by a qualified individual, the qualified individuals perform workflows based on the concern level of the recognized event.

It should now be apparent to one skilled in the art that a preferred embodiment of the invention permits objects (events) to be tracked across several image capture apparatus, such as by using a hybrid of cloud and edge computing, such as for example, if a machine, environmental condition, object or person moves around a location (such as a facility or an outdoor space) and the location is a very large location covered by multiple image capture apparatus. Thus, the same event visible in one image capture apparatus can be tracked using other image capture apparatus as it moves to other areas at the location. Further, if an event (or a recognized event) is determined to be similar to a previous event (or a recognized event), the analysis software can determine the probability that the event (or a recognized event) is the same event (or recognized event), such as within a threshold probability, and the entire history (movement and changes in attributes) can be recorded and used for future analysis.

### Automated Devices

It should also now be apparent that workflows can vary depending on the recognized event, the operation of a device and the equipment (components) being used. As used herein the terms “component” and “components” refer to individual parts, devices, equipment (including robotic equipment or devices), mechanical arms, mechanisms, apparatus, tool and systems of an automated device. As used herein the terms “operation” or “operations” refer to the processes, tasks, functions and actions being performed by one or more components or the overall function being performed by an automated device. Workflows can, for a non-limiting example, can include a qualified individual or group of individuals operating an automated device or a component; having one or more qualified individuals performing modifications or repair of an automated device or component; one or more qualified individuals performing a task or taking corrective action at a location (such as making a repair or handling a condition at a location); responding to an emergency at a location; or providing assistance to an individual at a location; and operations to be performed by an individual or an automated device. It should also now be apparent that the subject invention that certain workflows can perform various operations and in if there is a detected event, a workflow is performed automatically, such as by a robotic device on an automated device or by a separate movable device without the need of an individual. For a nonlimiting example, response software may determine that no qualified individual is needed to perform a workflow but instead the response software interacts with other software or a control apparatus of an automated device that can be utilized to perform a required workflow. Particularly, if the response to event can be potentially hazardous to an individual, such as, but limited to cleaning a hazardous spill or delivering a heavy object to a location and can be performed more safely by an automated device. Further, an automated device can perform various workflows in response to an event such as, but limited to, changing its operation, stopping its operation, performing various workflows such as, but not limited to, sending out notices of a malfunction, repairing or servicing components or other machines, performing maintenance, changing directions, such as along a path that the automated device is moving, changing speeds,

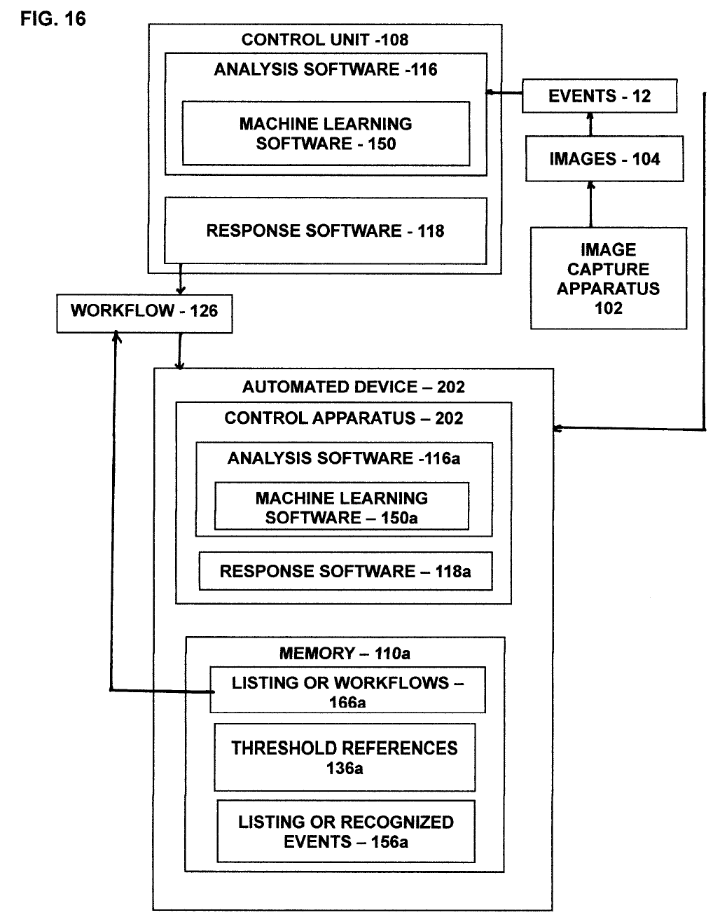

As shown in FIG. 16, in a preferred embodiment, an automated device 202 includes one or more image capture apparatus 102 that captures one or more images 104 which are transmitted to the control unit 108. Analysis software 116 operates to continuously monitor the captured images 104 and if it detects an event 12 (recognized event 124), as described above, it communicates with the response software 118 to initiate a response, such as determining or selecting a workflow (task) 126 based on the detected recognized event 124. It should be understood that the response software 118 can in a preferred embodiment operate such that no qualified individuals are identified or that no qualified individuals are required to perform the workflow 126 but instead the workflow will be performed by an automated device 202. It should now be understood that in a preferred embodiment of the invention, an automated device 202 has a control apparatus 204 having analysis software 116a with Machine Learning Software 150a can continuously monitor the captured images 104 taken by one or more image capture apparatus 102 to detect the occurrence of an event 12 and determines if the event 12 is a recognized event 124 from a listing of recognized events 156a stored in the memory 110a of the control apparatus 204. The analysis software 116a then selects a workflow 126 from a listing of workflows 166a stored in the memory 110a that is effective for responding to the detected event 12. Such control apparatus 204 for example can be a standard automation controller, such as a programmable logic controller (PLC) that operates using a high-level programming language to generate control commands that are passed to the various individual component control systems of the automated device and can also comprise various other computing hardware such as central processing units (CPU’s), graphics processing units (GPU’s), digital signal processors (DSP’s), microprocessors, field programmable gate arrays (FPGA’s), very large scale integration (VLSI) systems, complex programmable logic devices (CPLD’s), or systems on chips (SOC’s), and/or other such data processing and/or control devices that perform various operations. The workflow can include instructions or software modifications that are used to modify the programming of the control apparatus of the automatic device, such as a machining device or a robotic transport device or manufacturing device. For a non-limiting illustration, the workflow could provide modifications to the programming that would speed up or slow down all or part of an operation or an industrial operation being performed by the automated device or could turn on or off or adjust certain robotic or automated systems or a robotic device could be dispatched automatically to a location in response to a recognized event. It should be understood that workflow to respond to certain detected events may by subject to certain thresholds references 136a. For a non-limiting example, a recognized event in the form of a manufacturing device having a conveyor for moving objects and an event occurs such as an object falling off the conveyor may be below a threshold reference, such as below a threshold of a number of objects falling off a conveyor over a defined period of time. Accordingly, no workflow would be required until the number of objects falling off the conveyor in a defined amount of time reaches the threshold reference. In another non-limiting example, if the unloading mechanism at the unloading station of the conveyor is not placing the proper number of objects into a carton, the threshold reference is very low and a workflow would be implemented immediately upon detection of the event. It should also be understood, as described above, the analysis software 116a may determine that the workflow or a portion of the workflow requires an individual and the analysis software 116a may direct the response software 118a to identify and transmit a notice to one or more individuals qualified to perform the workflow or a portion of the workflow.

Referring to FIG. 17, an automated device 202 is shown in the form of a manufacturing device. In a preferred embodiment, the manufacturing device 202 has a conveyor 206 with a loading station 208 for loading objects 22 onto the conveyor 206 and an unloading station 210 for removing objects 22 from the conveyor 206. One or more image capture apparatus 102 transmits captured images 104 to a control unit 108 having analysis software 116 with Machine Learning Software 150 (AI programming) that uses the transmitted captured images 104 to detect an event 12, as described above, and response software 118 transmits a workflow 126 to control apparatus 204 of the automated device 202. The loading station 208 operates in conjunction with the unloading station 210 to receive an object stream 212 comprising a plurality of individual objects 20. In a preferred embodiment of the invention, the loading station 208 includes a loading mechanism 214, such as a chute, for aligning and placing an individual article 20 onto the conveyor 206. An image capture apparatus 102 is positioned such that it obtains captured images 104 cooperates with the analysis software 116 to ensure that objects 20 are in their proper alignment on the conveyor 206, such as by comparing captured images of objects 20 on the conveyor 206 with reference images 182 showing the proper placement of objects 20 on the conveyor 206. The analysis software 116 continuously monitors the captured images 104 and if an event 12 is detected, such as by comparing the captured images 104 with a list of recognized events 156 (such as stored images in an event database 170 depicting events, such as objects 22 in their proper position on the conveyor) an appropriate workflow 126 is determined, such as from a listing of workflows 166 for recognized events 124, and the appropriate workflow 126 is transmitted to the control apparatus 204 of the automatic device 202.

Another unlimiting example of the subject invention is shown in FIG. 18, whereby the conveyor 206 further includes an object unloading station 210, for receiving objects 22 being transported along the conveyor 206. As shown, the unloading station 210 comprises an unloading mechanism 216, such as a drop, that operates to deposit the objects 22 into a container or package 24 positioned on another conveyor or skid, or to location for further processing and a loading station 208 having a loading mechanism 214 that directly deposits objects 22 onto the conveyor 206. It should now be apparent to one skilled in the art that the loading mechanism 214 and the conveyor 206 may experience various disruptions that can result in object stream 212 not being consistent, such as objects not being placed in their proper position or orientation on the conveyor 206. This may result in the unloading mechanism 216 at the unloading station 210 not properly stacking objects 22 into a predetermined number of adjacent stacks having a desired proximity to each other. In a preferred embodiment, one or more image capture apparatus 102 operate to continuously or at predefined times capture images (captured images 104) are transmitted to the control apparatus 204 (or control unit 108 such as a central control) of the automatic device 202. The analysis software 116a, 116, monitors the captured images, as described above, 104 to detect an event 12, such as unloading mechanism 216 not properly unloading objects 22 as desired. If the event 12 does not meet a threshold reference 136 (such as for an example, but not limited to, the event only occurs occasionally below the threshold reference) the analysis software 116a, 116 does not direct response software 118a, 118, to direct a workflow 126 to an individual or to the control apparatus 204 to perform a workflow 126. If the detected event 12 meets or exceeds the threshold reference 136, the analysis software 116a, 116 directs the response software 118a, 118 to transmit a workflow 126 to the control apparatus 204 to respond the detected event 12. For a non-limiting example, the workflow could be stopping the operation of the automatic device or having the automatic device direct the objects to a different unloading station. In a preferred embodiment, as illustrated in FIG. 19, the analysis software, 116a, 116 further determines a concern level 158 for the recognized event 124, as described above. If the concern level 158 reaches a certain predefined concern level 158, the analysis software 116a, 116 determines if a qualified individual 16 is required to perform a workflow 126 and identifies qualified individuals 16 to perform the workflow 126, as described above, and/or transmits a warning notice 140 to one or more identified qualified individuals 16 input/output device 130.

Accordingly, in a preferred embodiment, as shown, the manufacturing device includes one or more image capture apparatus that continuously monitors objects being placed into a desired configuration, such as stacks, columns and/or rows or transferred to a second transfer mechanism, such as a second conveyor, for further processing using a conventional loading and unloading mechanisms. It should be understood that objects can be loaded onto the conveyor using a conventional loading mechanism, such as, but not limited to a drop, slide, gripping system or other mechanisms that operate to allow objects to drop onto the conveyor, such as a conventional conveyor or intelligent conveyor system, for moving the objects or stacks of objects to another system or a second location. It should also be understood that objects can be removed for the conveyor for further processing using conventional unloading mechanisms such as, but not limited to, drops, slides, gripping systems or other mechanisms that operate to remove objects from the conveyor and/or place the objects into containers and/or placing the objects into a desired number of stacks, rows, and columns. Such mechanisms often malfunction (event) and can result in significant damage to the objects and slow down production.

As shown in FIG. 20, in a preferred embodiment the automated device 202 is in the form of a machining device that produces objects 22, such as by performing a machining or forming operation. Such machining devices include, but are not limited to, drilling machines, industrial mixers, shredders, weight-lifting machines, cutting machines, presses, quality testing machines, textile production machines, hydraulic shears, surface treating machines, boring machines, milling machines, turning machines, lathes, EDM, EBM and ECM machines, ovens, molding machines, 3D printers and the like. Such machining devices (automated device) 202, such as but not limited to, cutting and drilling machining devices often require clamps 224 or other devices for securing a work piece in position on a fixture 226 for receiving a manufacturing operation to be utilized for gripping one or more edges of the work piece (object) 22 to secure the object 22 on the fixture 226 for processing. In many processing operations relatively large vertical, lateral and torquing forces act on the object and the clamps must be of sufficient strength to prevent the work piece object from being dislodged and expelled from the fixture. In many applications the object to be processed is relatively thin and/or narrow providing little surface area for engaging the clamp. Accordingly, the clamp is often required to secure the object by exerting pressure against relatively narrow portions of the object in such a manner to secure the object in position on the fixture. Unfortunately, machining devices are often robotically operated and an object may be mispositioned on the clamp or may dislodge from its proper position on the fixture that can result in the manufacturing operation being improperly performed and the manufactured object not meeting the desired specifications 228 for the object 22. Unfortunately, it is often difficult to detect such mispositioning of the clamp on the fixture or determining that a manufactured part (object) does not meet specification until a number of objects have been manufactured. While operators can be employed to observe such machining operations, this significantly increases the cost of the operation and reduces the benefits of the operations use of robotic mechanisms. Further, such manufacturing devices 202 often have safety mechanisms 222, such as shields, doors, guards, and other mechanism that are installed on a machining device 202 to prevent an operator from being injured during the machining operation. Often such safety mechanisms 222 are an inconvenience to operators in operating a machining device. Accordingly, operators have been known to remove such safety mechanisms to make their work easier to perform. Unfortunately, the removal of such safety mechanisms significantly increases the risk of injury to the operator. While manufacturing locations have supervisors and safety inspectors that routinely walk though a manufacturing space, they can miss detecting if a safety mechanism has been modified or removed. Further, operators often are aware when a supervisor or a safety inspector will be in a position to detected the modification or removal of the safety mechanism and the operator can reinstall or correct the safety mechanism until after the inspection.

As illustrated, the automated device 202 includes one or more image capture apparatus 102 that obtains images (captured images 104). The captures images 104 are transmitted to the control apparatus 204 of the automated device 202 (or to a control unit 108, such as a central control unit) having analysis software 116a, 116. The analysis software 116a, 116, monitors the captured images 104, as described above, to detect an event 12, such as an object 22 is not properly positioned (such as on a fixture) for a machining operation or a machining tool is not properly installed or has come out of alignment or has been damaged. If the event 12 does not meet or exceeds a threshold reference 136 (such as for an example, but not limited to, the event does not cause machining errors, a manufactured object meets design specifications within acceptable tolerance) the analysis software 116a, 116 does not direct response software 118a, 118, to direct a workflow 126 to an individual or to the control apparatus 204 to perform a workflow 126. If the detected event 12 meets or exceeds the threshold reference 136, the analysis software 116a, 116 directs the response software 118a, 118 to transmit a workflow 126 to the control apparatus 204 to respond the detected event 12. For a non-limiting example, the workflow could be stopping the operation of the machining device or transmitting an alarm, or having the machining device directing the objects to a different machining device for processing. In a preferred embodiment, the analysis software 116a, 116 further determines a concern level 158 for the event 12, as described above. If the concern level 158 reaches a certain predefined concern level 158, the analysis software 116a, 116 determines if an individual is required to perform a workflow 126 and identifies qualified individuals 16 to perform the workflow 126 and/or transmits a warning notice 140 to one or more identified qualified individuals 16 input/output device 130, as described above. In a preferred embodiment, as illustrated in FIG. 21, the captured images are color images (or monochromatic – gray scale images), collectively referred to as “color images” or “color captured images” 200a. The analysis software 116 than compares the color captured images 200a to previous color captured images 200b, as described above, to detect an event 12. In a non-limiting example, if the machining operation being performed by the automatic device 202 may include coloring of an object (change in color), such as by a form or coloring or coloring produced by heating or other operation. By comparing color captured images 200a to a previous captured image 200b (such as a previous color captured image or a reference color image of an object having the desired color), the analysis software can detect an event as described above.

In a preferred embodiment, as shown in FIG. 22, the automated device 202 is in the form of a robotic transport device that can navigate to a loading station 208 at one location to an unloading station 210 at another location. The robotic transport device 202 utilizes a trackless system whereby independent robotic transport devices 202 are freely driven along a predefined path 218 operating under the direction of a control unit 108 that provides control commands 220 to a control apparatus 204 of the robotic transport device 202 or can operate independently using a control apparatus 204 in communication with an outside input device 130, not shown, for transmitting control commands 220 to the control apparatus 204 of the robotic transport device 202. Preferably, each robotic transport device 202 operates in forward and reverse directions and can change directions to transport an object 22 in a predefined path 218 between a loading station 208, such as production stations, and an unloading station 210, and then follow a return predefined path 218 back to a loading station 208. Motion programming (such as the travel path, transport device speed, acceleration) are inputted into the control apparatus 204 directly or transmitted by an administrator’s input device or by the control unit 108. For an illustrative example, the control unit 108 provides executable motion programming (control commands) to the control apparatus 204 of the robotic transport device 202. The analysis software 116 of the control unit 108 operates to continuously or periodically monitor the robotic transport device 202 using captured images 104 transmitted to the control unit 108 by a one or more of image capture apparatus 102 positioned along the predefined path 218 or positioned within the operating location 10 and uses such captured images 104 to determine if the robotic transport device 202 will arrive at an unloading station 210 ahead of or behind its scheduled time and to identify any events 12 that may disrupt the motion (such as an article blocking the path of the robotic transport device or an event, such as a spill or other hazardous event occurring along the predefined path) or performance (such as an object falling off the automated device or a mechanical breakdown) of the robotic transport device 202.

As shown in FIG. 22, a schematic exemplary illustration of the robotic transport device 202 is shown having a control apparatus 204 and an image capture apparatus 102 both in communication with the overall system control unit 108 through a communication system 106. The predefined path 218 for the robotic transport device 202 is programmed by the control unit 108 for transmitting path control commands 220 that directs the robotic transport device 202 to travel from the loading station 208 to one or more unloading stations 210 within the location 10 to perform a workflow, such as delivering an object to a destination. It should be understood that the unloading station for the robotic transport device can be a loading or unloading station, a holding area, a recharging area, repair area, or a manufacturing or machining station (“collectively referred to as “unloading station”) that the robotic transport device is directed to travel to. It should also be understood that the loading station can include various unloading stations, such as various locations having objects to be loaded onto the automated device and moved to a desired unloading station. It should also be understood that image capture apparatus may be positioned along the predefined path or positioned at various locations within a facility (location) or can be mounted onto the automated device. Such image capture apparatus is used by a control unit and/or a control apparatus to obtain captured images that is used by analysis software to determine the location of the automated device as it travels along the predefined path and/or to determine if there is an event that affects the performance of the automated device (such as an object falling off the automated device or a component of the automated device misfunctions or an obstacle appears that disrupts the automated device from moving along the predefined path, thereby determining a concern level and performing a workflow based on the recognized event and concern level), further, the analysis software can use the captured images to identify the proper objects to be loaded onto the automated device at a loading station (such as comparing an image with reference images showing the image of the object to be loaded).

In a preferred embodiment, in operation, the control unit operates to control the independent robotic transport devices individual control commands to direct them along their predefined paths to move them to the various unloading stations. In a preferred embodiment, the control unit functions to synchronize the movements of the robotic transport devices within the operating location.

In another preferred embodiment, as illustrated in FIG. 23, the automated device 202 is in the form of a movable robotic device having various robotic components 232 and a control apparatus 204 having analysis software 116 that receives captured images 104 (or a video stream) from one or more image capture apparatus 102 that transmits said captured images 102 to a control apparatus 204 that directs response software 118 to control the operation of an automated device 202. For a non-limiting example, such as when the automated device 202 is moved to a location 10 to perform an operation at the location 10 or moved to a machine or manufacturing system 30 to perform repairs or perform other workflows 126 in response to a recognized event 124, such as, but not limited to, cleaning a spill or other task at the location 10 or performing maintenance or repairs on the machine or manufacturing system 30, and the like (collectively referred to as “robotic operations”). In a preferred embodiment, the control commands 220, includes speed and direction of movement of the automated device 202, and includes control commands 220 for the operation of the various components 232 (such as but not limited to robotic arms) on the automated device 202 designed to perform various robotic operations that are programmatically inputted, such as by use of the input devices used by an administrator or transmitted to the control apparatus 204 from a control unit 108 through the communication system 106. Response software 118 determines the workflow 126 for the recognized event 124 using the listing of workflows 166 stored in the workflow databank 164 (FIG. 10) and transmits the workflow and control commands 220 for directing the automated device 202 to perform the workflow 126. It should also be understood that the workflow can be determined using Machining Learning Software (AI programming) of the analysis software. It should be understood that in a preferred embodiment the control commands and the operation of the automated device and/or its various components, is controlled by the control apparatus using analysis software, preferably using Machine Learning Software, of the automated device without the need to receive control commands from the control unit, thus, the automated device works independently to perform workflows for responding to recognized events identified by the analysis software of the control apparatus. Accordingly, the system 100 uses captured images to detect an event, such as malfunctioning of a machine or manufacturing system or to a location having an event and directs an automated device to the machine or manufacturing system location and directs the automated device to implement the workflow to response to the recognized event to perform an operation in response to the recognized event. In a preferred embodiment, the robotic device can include image capture apparatus that takes images of the workflow being performed by the robotic device and such images are transmitted to the analysis software that uses Machine Learning Software to direct the operation being performed be the automated device. For a non-limiting example, the analysis software can monitor the workflow being performed using various components of the automated device to ensure that the workflow, such as repairs to a machine, is being properly performed. It should also be understood that the work being performed by the automated device can be monitored by the administrator using the administrator’s input/output device and control commands can be transmitted to the control apparatus to direct the various components to perform certain functions, such as to perform certain operations, such as a workflow, in response to a recognized event.

It should now be apparent that the subject invention is a system for managing workflows for observed events comprising a control unit that functions to monitor and control the operation of the overall system having analysis software and response software; one or more image capture apparatus that captures images at a location and transmits said captured images to the control unit; an automated device having control apparatus that can receive control commands from the control unit and preferably has analysis software that can operate independently; wherein the analysis software includes Machine Learning Software; wherein the analysis software continuously monitors captured images and uses the Machine Learning Software to detect the occurrence of an event. If the analysis software detects an event, the analysis software determines if the detected event is a recognized event. Preferably, the analysis software detects the event by using changes in pixels between the captured images over a time period. The analysis software preferably also determines a concern level for the recognized event and determines a workflow to respond to the recognized event preferably based on the concern level and transmits the workflow to a control apparatus of an automated device. The control apparatus performs the workflow that modifies the operation of the automated device. In a preferred embodiment the system for managing workflows for observed events, the automated device is in the form of a manufacturing device. In another preferred embodiment the system for managing workflows for observed events, the automated device is in the form of a machining device. In another preferred embodiment of the invention the system for managing workflows for observed events, the automated device is in the form of a robotic transport device or a movable robotic device. In another preferred embodiment of the invention the automated device is in the form of a manufacturing device having a conveyor, a loading station having a loading mechanism for placing objects in their proper position on the conveyor forming an object stream and an unloading station having an unloading mechanism for removing the objects from said conveyor. One or more image capture apparatus comprises one or more cameras position to capture images of the conveyor and/or the loading station and/or the unloading station and/or the object stream of the automated device and wherein the captured images are used to identify an event. If the event is a recognized event, the response software transmits a workflow to the analysis software modifies or controls the operation of the automated device. In a preferred embodiment, depending on the recognized event and preferably the concern level, the workflow stops operation of the automated device, or adjust the speed of the conveyor; or directs the object stream to different unloading station. In another preferred embodiment of the invention the system for managing workflows for observed events the automated device is in the form of a machining device having a fixture for securing a work piece in position for machining. Captured images are images of the fixture and the work piece mounted to the fixture. If the recognized event is a work piece not being properly positioned on the fixture for machining, the analysis directs the response software to stop operation of the automated device and/or transmits a notice to a machine operator. In another preferred embodiment of the invention, the automated device is in the form of a machining device and includes a safety mechanism on the automated device. The captured images include images of the safety mechanism and uses the captured images to identify an event. If the analysis software determines that the event is a recognized event, and wherein if the event is a recognized event, such as a modification or removal of the safety mechanism, the analysis directs the response software to stop operation of the automated device and/or transmits a notice to an administrator. In another preferred embodiment of the invention, the analysis software examines pixels of the captured images and compares the pixels of the captured images with pixels of reference images to identify an event in the captured images. In another preferred embodiment the analysis software compares changes in the pixels between the captured images and pixels of reference images, if the change in the pixels exceeds a threshold reference, the analysis software directs the response software to determine a workflow based on the concern level for responding to the recognized event and transmits the workflow to the control unit or the control apparatus. In a preferred embodiment, the captured images are images of a work piece after machining and the analysis software compares change in the pixels between the captured images and the reference images and uses the change in pixels to determine if a work piece after machining is within design specifications. If the work piece is outside the design specification, the analysis software directs the response software to determine a workflow for responding to the recognized event and transmits the workflow to the control unit or the control apparatus. In another preferred embodiment, the automated device is in the form of a robotic transport device freely driven along a predefined path having a loading station and an unloading station. One or more image capture apparatus are mounted on the automated device for capturing images of a location along the predefined path as the automated devices travels along said predefined path. The analysis software continuously monitors the captured images to identify an event and determines if the event is a recognized event. If the event is a recognized event, the response software transmits a workflow, based preferably on the concern level of the recognized event, to the control unit or the control apparatus. If the concern level is below a concern level threshold, the control apparatus performs the workflow by directing the automated device to stop moving along the predefined path until the recognized event is eliminated or if the concern level is equal to or exceeds the concern level threshold, the control apparatus performs the workflow by directing the automated device to move along a new predefined path. In a preferred embodiment, the response software determines if an individual is needed to perform the workflow. If it is determined that the individual is needed to perform the workflow, the response software selects one or more qualified individuals from a listing of qualified individuals who are qualified to perform the workflow and transmits the workflow and the concern level to individuals input/output device of each one or more selected one or more qualified individuals. In a preferred embodiment of the invention, if one or more selected qualified individuals are performing other workflows having concern values, the one or more selected qualified individuals perform the workflows in order of the concern values. In a preferred embodiment the analysis software identifies an event by examining changes in the pixels, RGB values and patterns of the captured images. In a preferred embodiment, the automated device is moved to a location to perform repairs or perform other workflows (robotic operations) in response to a recognized event. The control commands control the operation of various specific components on the automated device designed to perform various robotic operations and are programmatically inputted, such as by use of the input devices used by an administrator or transmitted to the control apparatus from the control unit. It should be understood that in a preferred embodiment the control commands and the operation of the automated device and/or its various components, are controlled by the control apparatus using analysis software, preferably using Machine Learning Software, of the automated device without the need to receive control commands from the control unit, thus, the automated device works independently to perform workflows for responding to recognized events identified by the analysis software of the control apparatus.

It should now be apparent that in preferred embodiments of the invention the system for managing workflows for observed events comprises a control unit having analysis software and response software; one or more image capture apparatus that captures images at a location and transmits the captured images to the control unit; an automated device having control apparatus; wherein, the analysis software of the control unit includes Machine Learning Software; wherein, the analysis software of the control unit continuously monitors the captured images and uses the Machine Learning Software to detect the occurrence of an event, if the analysis software detects an event, the analysis software determines if the detected event is a recognized event; wherein, the analysis software detects the event by using changes in pixels between the captured images over a time period; wherein, the analysis software determines a concern level for the recognized event; wherein, the response software determines a workflow to respond to the recognized event based on the concern level and transmits the workflow to a control apparatus of an automated device; and wherein, the control apparatus performs the workflow that modifies the operation of the automated device.

In another preferred embodiment, automated device is in the form of a manufacturing device. In another preferred embodiment, the automated device is in the form of a machining device. In another preferred embodiment, the automated device is in the form of a robotic transport device. In another preferred embodiment, the automated device is in the form of a movable robotic device.

In another preferred embodiment, the automated device is in the form of a manufacturing device having a conveyor, a loading station having a loading mechanism for placing objects in their proper position on the conveyor forming an object stream and an unloading station having a unloading mechanism for removing the objects from the conveyor; wherein, the one or more image capture apparatus comprises one or more cameras position to capture images of the conveyor, and/or the loading station and/or said unloading station and/or the object stream of the automated device and wherein, the captured images are used to identify an event; wherein, if the event is a recognized event, the response software transmits a workflow to the analysis software that modifies the operation of the automated device; and wherein, depending on the recognized event and the concern level, the workflow stops operation of the automated device, or adjust the speed of the conveyor; or directs the object stream to different unloading station.

In a preferred embodiment, the automated device is in the form of a machining device; wherein, the automated device includes a fixture for securing a work piece in position for machining; wherein, the captured images are images of the fixture and the work piece mounted to the fixture; and wherein, if the recognized event is a work piece not properly positioned on the fixture for machining, the analysis directs the response software to stop operation of the automated device and/or transmits a notice to a machine operator.

In a preferred embodiment, the automated device is in the form of a machining device; wherein, the automated device includes a safety mechanism on the automated device; wherein, the captured images include images of the safety mechanism and uses the captured images to identify an event; wherein, the analysis software determines if the event is a recognized event; and wherein, if the event is a recognized event and the recognized event is a modification or removal of the safety mechanism the analysis directs the response software to stop operation of the automated device and/or transmits a notice to an administrator. In a preferred embodiment, the analysis software examines pixels of the captured images and compares the pixels of the captured images with pixels of reference images to identify an event in the captured images.

In a preferred embodiment, the analysis software compares changes in the pixels between the captured images and pixels of reference images, if the change in the pixels exceeds a threshold reference, the analysis software directs the response software to determine a workflow based on the concern level for responding to the recognized event and transmits the workflow to the control unit or the control apparatus.

In a preferred embodiment, the captured images are images of a work piece after machining and the analysis software compares changes in the pixels between the captured images and the reference images and uses the change in pixels to determine if a work piece after machining is within design specifications and wherein if the work piece is outside the design specification, the analysis software directs the response software to determine a workflow for responding to the recognized event and transmits the workflow to the control unit or the control apparatus.

In a preferred embodiment, the automated device is in the form of a robotic transport device freely driven along a predefined path having a loading station and an unloading station; wherein, one or more image capture apparatus is mounted on the automated device for capturing images of a location along the predefined path as the automated devices travels along the predefined path; wherein, the analysis software continuously monitors the captured images to identify an event and determines if the event is a recognized event; wherein, if the event is a recognized event, the response software transmits a workflow based on the concern level of the recognized event to the the control unit or the control apparatus; wherein, if the concern level is below a concern level threshold, the control apparatus performs the workflow by directing the automated device to stop moving along the predefined path until the recognized event is eliminated or if the concern level is equal to or exceeds the concern level threshold, the control apparatus performs the workflow by directing the automated device to move along a new predefined path. In a preferred embodiment, the response software determines if an individual is needed to perform the workflow, wherein, if it is determined that the individual is needed to perform the workflow, the response software selects one or more qualified individuals from a listing of qualified individuals who are qualified to perform the workflow and transmits the workflow and the concern level to individuals input/output device of each of the one or more selected one or more qualified individuals. Preferably, if the one or more selected qualified individuals are performing other workflows having concern values, the one or more selected qualified individuals perform the workflows in order of the concern values.

In a preferred embodiment, the analysis software identifies an event by examining changes in the pixels, RGB values and patterns of the captured images.

A preferred embodiment of the invention the system for managing workflows for observed events comprises: a control unit; one or more image capture apparatus that captures images at a location and transmits the captured images to the control unit; an automated device having control apparatus that cooperates with the control unit to control the operation of the automated device; wherein, the control unit and/or control apparatus has analysis software that includes Machine Learning Software; wherein, the analysis software continuously monitors the captured images and uses the Machine Learning Software to detect the occurrence of an event, if the analysis software detects an event, the analysis software determines if the detected event is a recognized event; wherein, the analysis software detects the event by comparing pixels between the captured images and reference images; wherein, the analysis software determines a concern level for the recognized event; wherein, the response software determines a workflow to respond to the recognized event based on the concern level; and wherein, the control apparatus performs the workflow by modifying the operation of the automated device.

A preferred embodiment of the system for managing workflows of observed events comprises: a control unit having analysis software having Machine Learning Software and response software; an automated device in the form of a movable robotic device that moves along a predefined path, the automated device having robotic components and a control apparatus, response software and analysis software with Machine Learning Software; one or more image capture apparatus that captures images of a location or of a machine or manufacturing system and transmits the captured images to the control unit; wherein the analysis software of the control unit uses the captured images to detect an event and determine if the event is a recognized event; wherein the response software of the control unit determines a workflow and transmits the workflow to the control apparatus; wherein the response software of the control apparatus uses control commands to move the automated device to the location or to the machine or manufacturing system and directs the automated device to perform the workflow at the location or on the machine or manufacturing system; wherein the automated device has one or more image capture apparatus that captures images and transmits the captured images of the workflow being performed by the automated device at the location or on the machine or manufacturing system; wherein, the analysis software of the automated device uses the captured images to monitor the workflow being performed at the location or on the machine or manufacturing system by the automated device and uses Machine Learning Software to determine robotic control commands to control robotic components performing the workflow.

### Operations

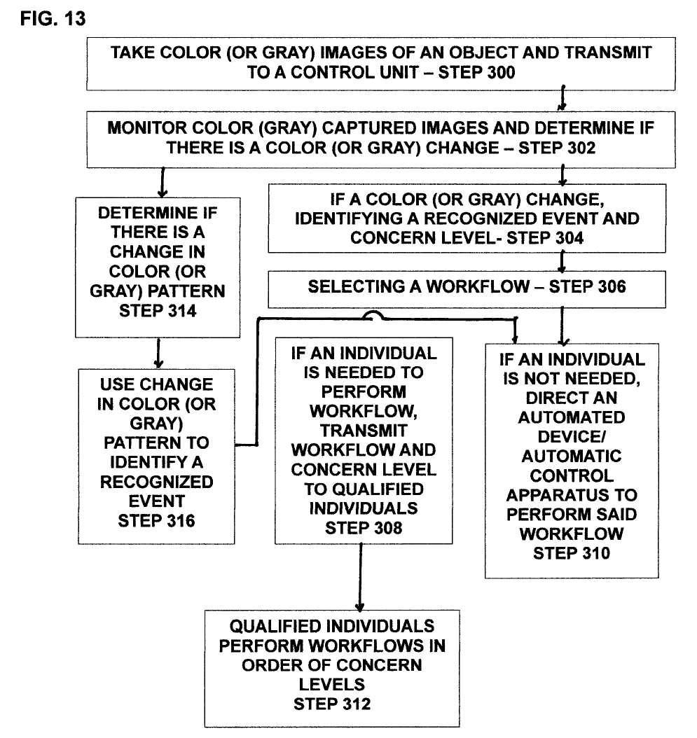

As illustrated in FIG. 13, a method for managing workflows for observed events comprises the steps of: taking images of an object and transmitting the captured images to a control unit or control apparatus (step 300); monitoring the captured images to determine if there is a change in color (or gray scale) from a captured image and a previous captured image using changes in the pixels and their RGB values between the current captured image and a previous captured image (step 302); if there is a color change (or gray scale change) between said captured image and the previous captured image, a recognized event is identified and a concern value for the recognized event is determined (step 304); a workflow for the identified recognized event is selected (step 306); if an individual is needed to perform the workflow is determined and if it is determined that an individual is needed to perform the workflow, one or more qualified individuals are identified who are qualified to perform the workflow and the workflow and concern level is transmitted to the identified qualified individuals input/output devices (step 308), and wherein if it is determined that an individual is not needed to perform the workflow, interacting with the control unit of the system and/or with one or more automated control apparatus controlling automated device to perform the workflow (step 310); and if is determined that an individual is needed to perform the workflow, and wherein if one or more qualified individuals are performing other workflows having concern levels, the one or more qualified individuals perform the workflows in order of their concern levels (step 312). In a preferred embodiment, the method further comprises the steps of determining changes in color (or gray) patterns between a first captured image and a second captured image (step 314) and using the changes in color (or gray) pattern to identify a recognized event (step 316) and/or using a time period between the first captured image and the second captive image showing a color (or gray) change and using the time period to identify a recognized event and/or a concern level for the recognized event.

In a preferred embodiment the method includes the steps of determining if an individual is needed to perform the workflow (step 318) and if it is determined that an individual is needed to perform the workflow; selecting one or more qualified individuals who are qualified to perform the workflow (step 320) and transmitting the workflow and the concern level to individuals input/output device of each selected one or more qualified individuals (step 322), and wherein if it is determined that an individual is not needed to perform the workflow, interacting with one or more control apparatus controlling the automated device to perform the workflow (step 324); and if is determined that an individual is needed to perform the workflow, and wherein if one or more qualified individuals are performing other workflows having concern levels, the one or more qualified individuals perform the workflows in order of their concern levels (step 326).

In view of the foregoing, the subject invention provides a systems and methods whereby images of an object can be analyzed and changes on color or a color pattern (or shades of gray or gray patterns) of the object can be detected and analyzed and specific responses (workflows) can be selected for responding to the particular change in the color or the color pattern (shades of gray or gray patterns) of the object. Further, a concern level can be determined for the particular color change or color pattern (or shades of gray or gray patterns) change. Thus, unlike previously designed systems that simply detect a color change (no particular color change or changes in gray) and a response for a color (or shades of gray) change in general, the system and method of the subject invention allow for a specific response (workflow) to be selected for a specific color change or color pattern change (or shades of gray or gray patterns). The system and method further provide that an administrator can define selected portions of captured images and define workflows and concern levels for color or color pattern (or shades of gray or gray patterns) changes in the selected portions. For example, a color or color pattern (or shades of gray or gray patterns) changes are used to define or identify events within a defined portion of captured images and depending on the recognized event, a workflow can be selected for responding to the recognized event, such as, but not limited to sending out alerts, identifying qualified individual(s) to respond to the recognized event and communicating with the qualified individua(s) and providing the workflow and concern level for responding to the recognized event, or communicating with control apparatus of automated devices hat then directs the automated device to respond to the recognized event. Thus, the subject invention detects color (or shades of gray) or color (or gray) pattern changes shown in live video streams or sequence of images to identify events, unlike prior art systems that simply detect a color. It should also be understood, that in addition to color the system can also analyze color saturation, hue and brightness changes to further identify a recognized event and determine a workflow and concern level for the recognized event. Further, the system can also determine the area (size, such as the for example, the square inch area where there is a color (or shades of gray) or color (or gray) pattern change and/or the time period by which the color (or shades of gray) or color (or gray) pattern took place, to determine a recognized event, workflow and concern level. For a non-limiting example, if the color change occurred over a relatively short time period, the concern level may be higher than a color change having occurred over a relatively long time period. For a non-limiting illustration, if a color change or color pattern change on a machine surface occurred over a relatively long time period, the workflow could simply be slowing down the operation of a machine or cooling the temperature in the area of the machine, whereas if the color change or color pattern change occurred over a relatively short time period, the workflow could be shutting down the machine or that a part, such as a bearing, must be replaced immediately to prevent additional damage to the machine.

Although the foregoing invention has been described in some detail for purposes of clarity of understandings, it will be apparent that certain changes and modifications may be practiced within the scope of the appended claims. Accordingly, it should also now be apparent that the various embodiments presented can be easily modified while keeping within the scope and spirit of the subject invention. It should also be understood that the present disclosure is to be considered as exemplary of the principals of the invention and is not intended to limit the invention to the embodiments and the specific examples illustrated and the invention is not to be limited to the details given herein, but may be modified within the scope and equivalents of the descriptions and examples contained herein.

1. A system for managing workflows for observed events comprising:
a control unit having analysis software and response software;
one or more image capture apparatus that captures images at a location
and transmits said captured images to said control unit;
an automated device having control apparatus for controlling the operation
of said automated device;
wherein, said analysis software includes Machine Learning Software;
wherein, said analysis software continuously monitors said captured
images and uses said Machine Learning Software to detect the occurrence of an event, if said analysis software detects an event, said analysis software determines if said detected event is a recognized event;
wherein, said Machine Learning Software detects the event by using
changes in pixels between said captured images over a time period;
wherein, said analysis software determines a concern level for said
recognized event based on said changes in said pixels between said captured images over said time period;
wherein, said response software determines a workflow to respond to said
recognized event based on said concern level and transmits said workflow to a control apparatus of an automated device; and
wherein, said control apparatus performs said workflow that modifies the
operation of said automated device.

2. The system for managing workflows for observed events of claim 1, wherein, said
automated device is in the form of a manufacturing device.

3. The system for managing workflows for observed events of claim 1, wherein, said
automated device is in the form of a machining device.

4. The system for managing workflows for observed events of claim 1, wherein, said
automated device is in the form of a robotic transport device.

5. The system for managing workflows for observed events of claim 1, wherein, said automated device is in the form of a movable robotic device having one or
more components that perform said workflow.

6. The system for managing workflows for observed events of claim 1, wherein, said
automated device is in the form of a manufacturing device having a
conveyor, a loading station having a loading mechanism for placing objects in their proper position on said conveyor forming an object stream and an unloading station having an unloading mechanism for removing the objects from said conveyor;
wherein, said one or more image capture apparatus comprises one or more
cameras position to capture images of said conveyor and/or said loading station and/or said unloading station and/or said object stream of said automated device and wherein, said captured images of said conveyor and/or said loading station and/or said unloading station and/or said object stream are used to identify an event;
wherein, if the event is a recognized event, said response software
transmits said workflow to said control apparatus that modifies the operation of said automated device; and
wherein, depending on said recognized event and said concern level, said
workflow stops operation of said automated device, or adjust the speed of said conveyor; or directs said object stream to different unloading station.

7. The system for managing workflows for observed events of claim 1, wherein, said
automated device is in the form of a machining device;
wherein, said automated device includes a fixture for securing a work piece
(object) in position for machining;
wherein, said captured images are images of said fixture and the work piece
mounted to said fixture; and
wherein, if said recognized event is that the work piece is not properly
positioned on said fixture for machining, said workflow stops operation of said automated device and/or is the response software directing notice to a machine operator.

8. The system for managing workflows for observed events of claim 1, wherein, said
automated device is in the form of a machining device;
wherein, said automated device includes a safety mechanism on said
automated device;
wherein, said captured images include images of said safety mechanism
and uses said captured images of said safety mechanism to identify
an event;
wherein, said analysis software determines if the event is a recognized
event; and
wherein, if said event is a recognized event and said recognized event is a
modification or removal of said safety mechanism, said workflow stops the operation of said automated device and/or directs said response software to transmit a notice to an administrator.

9. The system for managing workflows for observed events of claim 7, wherein, said
analysis software examines pixels of said captured images of the work piece on said fixture and compares said pixels of said captured images with pixels of reference images to identify an event in said captured images.

10. The system for managing workflows for observed events of claim 7, wherein, said analysis software compares changes in said pixels between said captured images of the work piece on said fixture and pixels of reference images, if said change in said pixels between said captured images and said reference images exceed a threshold reference, said analysis software directs said response software to determine a workflow based on said concern level for responding to said recognized event and transmits said workflow to said control unit or to said control apparatus.

11. The system for managing workflows for observed events of claim 7, wherein, said captured images are images of a work piece (object) after machining and said analysis software compares change in said pixels between said captured images of the work piece after machining and said reference images and uses said change in pixels to determine if a work piece after machining performed by said automated device is within design specifications and wherein if said work piece (object) is outside said design specification, said analysis software directs said response software to determine a workflow for responding to said recognized event and transmits said workflow to said control unit or to said control apparatus.

12. The system for managing workflows for observed events of claim 1, wherein, said
automated device is in the form of a robotic transport device freely
driven along a predefined path having a loading station and an unloading station;
wherein, one or more image capture apparatus is mounted on said
automated device for capturing images of a location along said predefined path as said automated devices travels along said predefined path;
wherein, said analysis software continuously monitors said captured
images along said predefined path to identify an event and determines if an event is a recognized event;
wherein, if said identified event is a recognized event, said response
software transmits a workflow based on said concern level of said recognized event to said control apparatus of said automated device;
wherein, if said concern level is below a concern level threshold, said control
automated device performs said workflow by directing said automated device to stop moving along said predefined path until said recognized event is eliminated (no longer exist) or if said concern level is equal to or exceeds said concern level threshold, said automated device performs said workflow by moving along a new predefined path.

13. The system for managing workflows for observed events of claim 1, wherein, said
response software determines if an individual is needed to perform said workflow, wherein, if it is determined that the individual is needed to perform said workflow, said response software selects one or more qualified individuals from a listing of qualified individuals who are qualified to perform said workflow and transmits said workflow and said concern level to individuals input/output device of each said one or more selected one or more qualified individuals.

14. The system for managing workflows for observed events of claim 13, if said one
or more selected qualified individuals are performing other workflows having concern values, said one or more selected qualified individuals perform said workflows in order of said concern values.

15. The system for managing workflows of observed events of claim 1, wherein, said
analysis software using said Machine Learning Software identifies an event by examining changes in said pixels, RGB values and patterns of said captured images.

16. A system for managing workflows for observed events comprising:
an automated device having control apparatus that controls the operation
of said automated device;
one or more image capture apparatus that captures images at a location
and transmits said captured images to said control apparatus;
wherein, said control apparatus has analysis software that includes
Machine Learning Software and response software;
wherein, said analysis software continuously monitors said captured
images and uses said Machine Learning Software to detect the occurrence of an event, if said analysis software detects an event, said analysis software determines if said detected event is a recognized event;
wherein, said Machine Learning Software detects the event by comparing
pixels between said captured images and reference images;
wherein, said analysis software determines a concern level for said
recognized event;
wherein, said response software determines a workflow to respond to said
recognized event and based on said concern level; and
wherein, said automated device performs said workflow by modifying the
operation of said automated device.

17. The system for managing workflows for observed events of claim 16, wherein, said automated device is in the form of a manufacturing device.

18. The system for managing workflows for observed events of claim 16, wherein, said automated device is in the form of a machining device.

19. The system for managing workflows for observed events of claim 16, wherein, said automated device is in the form of a robotic transport device.

20. The system for managing workflows for observed events of claim 16, wherein, said response software determines if an individual is needed to perform said workflow, wherein, if it is determined that the individual is needed to perform said workflow, said response software selects one or more qualified individuals from a listing of qualified individuals who are qualified to perform said workflow and transmits said workflow and said concern level to individuals input/output device of each said one or more selected one or more qualified individuals.

21. The system for managing workflows for observed events of claim 20, if said one
or more selected qualified individuals are performing other workflows having concern values, said one or more selected qualified individuals perform said workflows in order of said concern values.

22. The system for managing workflows of observed events of claim 16, wherein, said
analysis software identifies an event by examining changes in said pixels, RGB values and patterns of said captured images.

23. A system for managing workflows of observed events comprising:
a control unit having analysis software having Machine Learning Software and
response software;
an automated device in the form of a robotic movable device that moves along a
predefined path, the automated device having robotic components and a control apparatus having response software and analysis software with Machine Learning software;
one or more image capture apparatus that captures images of a location or of a
machine or manufacturing system and transmits said captured images to a control unit having analysis software;
wherein said analysis software of said control unit has Machine Learning
Software and said Machine Learning software of said control unit uses said captured images to detect an event and determine if the event is a recognized event;
wherein if said event is a recognized event, said response software of said control
unit determines a workflow and transmits said workflow to said control apparatus;
wherein said response software of said control apparatus uses control commands
to move said automated device to the location or to the machine or manufacturing system and directs said automated device to perform said workflow at the location or on said machine or manufacturing system;
wherein said automated device has one or more image capture apparatus that
captures images of said workflow being performed by said automated device and transmits said captured images of said workflow being performed by the automated device;
wherein, said analysis software of said automated device uses said captured
images of said workflow being performed by said automated device to monitor said workflow being performed by said automated device and uses said Machine Learning Software to determine robotic control commands and said robotic control commands to direct said robotic components to perform said workflow or to modify said workflow being performed by said automated device.

24. The system for managing workflows for observed events of claim 23, wherein, said analysis software of said control unit examines pixels of said captured images and compares said pixels of said captured images with pixels of reference images to identify an event.
